(19) United States
(12) Patent Application Publication
(10) Pub. No.: US 2025/0214291 A1
(43) Pub. Date: Jul. 3, 2025

(54) CONTROL DEVICE FOR INJECTION MOLDING MACHINE

(71) Applicant: SUMITOMO HEAVY INDUSTRIES, LTD., Tokyo (JP)

(72) Inventor: Yutaka TSUTSUMI, Chiba (JP)

(21) Appl. No.: 18/933,023

(22) Filed: Oct. 31, 2024

(30) Foreign Application Priority Data
Dec. 27, 2023 (JP) 2023-221886

(51) Int. Cl. B29C 45/76

(52) U.S. Cl. CPC B29C 45/7653; B29C 2945/761; B29C 2945/76702; B29C 2945/76869

(57) ABSTRACT

A control device for controlling an injection molding machine includes a mold device having a fixed mold and a movable mold; a mold clamping device to open and close the fixed and movable molds; and an injection device to inject a molding material into the mold device; and circuitry to acquire an allowable amount between the fixed and movable molds for preventing discharge of the injected molding material from the mold device, and acquire a gap size for discharging a gas between the fixed and movable molds, and adjust a mold clamping force of the mold clamping device such that a value obtained based on an opening size between the fixed and movable molds generated by injection of the molding material and the gap size satisfies a condition according to the allowable amount when the molding material is injected into the mold device closed by the mold clamping device.

### CROSS-REFERENCE TO RELATED APPLICATIONS

This application is based upon and claims priority to Japanese Patent Application No. 2023-221886 filed on Dec. 27, 2023, the entire contents of which are incorporated herein by reference.

### BACKGROUND

### 1. Technical Field

The present disclosure relates to a control device for an injection molding machine.

### 2. Description of Related Art

Conventionally, injection molding machines are equipped with a mold device that includes a fixed mold and a movable mold, a mold clamping device that clamps the mold device, and an injection device that fills the inside of the mold device with molding material. When the injection device fills the mold device with the molding material, the mold clamping device needs to close the mold device with an appropriate mold clamping force.

A method for setting a mold clamping force disclosed in the related art generates a mold clamping force with two or more different clamping force settings to perform injection, and detects the clamping force during the injection. Then, a relational expression between the maximum value of the detected clamping force and the set clamping force is obtained, and a clamping force at which the maximum value of the detected clamping force and the set clamping force are equal to each other is obtained from the relational expression, and the obtained clamping force is set.

### SUMMARY

According to an embodiment of the present disclosure, a control device for controlling an injection molding machine is provided. The control device includes:
a mold device having a fixed mold and a movable mold;
a mold clamping device configured to open and close the fixed mold and the movable mold;
an injection device configured to inject a molding material into the mold device; and
circuitry configured to
   acquire an allowable amount as a size of a gap allowable between the fixed mold and the movable mold for preventing discharge of the molding material from the mold device when the molding material is injected into the mold device, and acquire a gap size indicating a size of a gap provided for discharging a gas between the fixed mold and the movable mold, and
   adjust a mold clamping force of the mold clamping device such that a value obtained based on an opening size and the gap size satisfies a condition according to the allowable amount when the molding material is injected into the mold device closed by the mold clamping device, the opening size indicating a size of a gap between the fixed mold and the movable mold generated by injection of the molding material.

### BRIEF DESCRIPTION OF THE DRAWINGS

FIG. 1 is a diagram illustrating a state of an injection molding machine according to an embodiment at the time of completion of mold opening.

FIG. 2 is a diagram illustrating a state of the injection molding machine according to the embodiment when the mold is clamped.

FIG. 3 is a diagram illustrating an example of a functional configuration of a control device according to the embodiment.

FIG. 4 is a diagram illustrating an example of a series of steps of a molding cycle according to the embodiment.

FIG. 5 is a cross-sectional diagram illustrating an example of a molding material flowing into the inside of a metal mold device according to the embodiment.

FIG. 6 is a cross-sectional diagram illustrating the mold device according to the embodiment.

FIG. 7 is a cross-sectional diagram illustrating a state in which parting surfaces of the mold device according to the embodiment is opened.

FIG. 8 is a diagram illustrating a table structure of a maximum allowable value storage unit according to the embodiment.

FIG. 9 is a cross-sectional diagram illustrating an example of an effective length of a tie bar according to the embodiment.

FIG. 10 is a diagram illustrating an example of time variation of actual values of mold clamping force.

FIG. 11 is a diagram illustrating an example of a setting screen output to a display device by an output control unit according to the embodiment.

FIG. 12 is a flowchart illustrating a process procedure for adjusting a reference mold clamping force, which is executed by a control device according to the embodiment.

FIG. 13 is a diagram illustrating an example of a log information screen output by the output control unit according to the embodiment.

FIG. 14 is a diagram illustrating a gap size display screen output by the output control unit according to the embodiment.

### DETAILED DESCRIPTION

As disclosed in the related art, the method for setting a mold clamping force has been proposed. However, it is difficult to derive an appropriate mold clamping force. For example, when the mold clamping force is small, the fixed mold and the movable mold are opened by the pressure of the molding material, and the molding material leaks, resulting in the formation of burrs. That is, it is necessary to adjust the mold clamping force in consideration of the opening size of a mold device.

According to one aspect of the present disclosure, a technique is provided for reducing the occurrence of molding defects.

According to one aspect of the present disclosure, the mold clamping force of the mold clamping device can be adjusted to reduce the occurrence of molding defects.

Hereinafter, embodiments of the present disclosure will be described with reference to the accompanying drawings. The embodiments described below are not intended to limit the present disclosure but are merely examples, and all features and combinations thereof described in the embodiments are not necessarily essential to the present disclosure. In the drawings, the same or corresponding components are denoted by the same or corresponding reference numerals, and the description thereof may be omitted.

### Embodiment

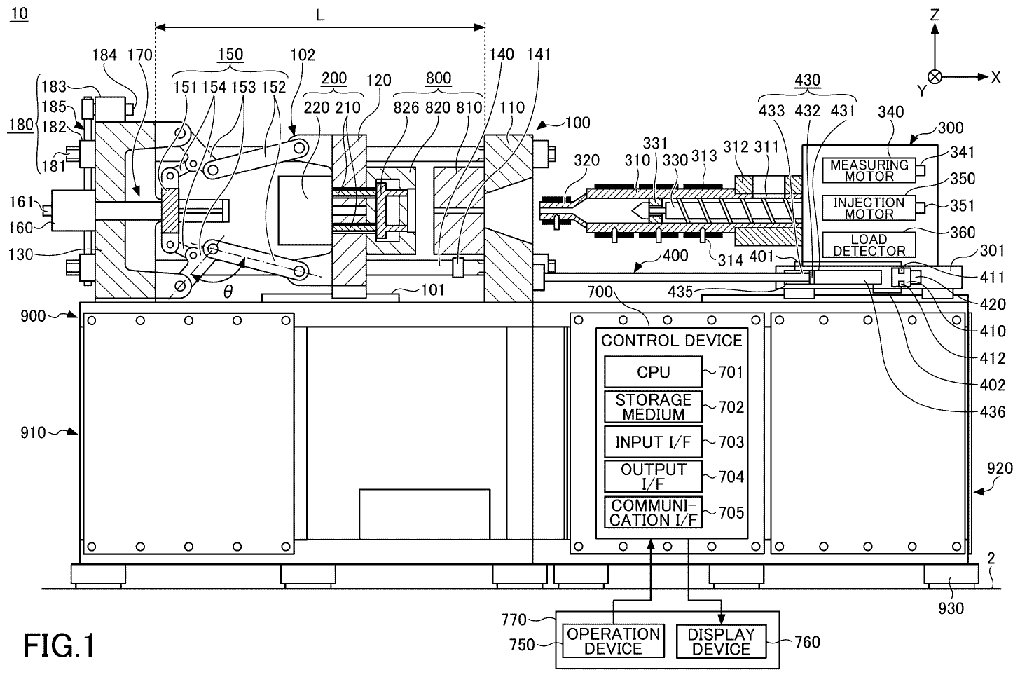

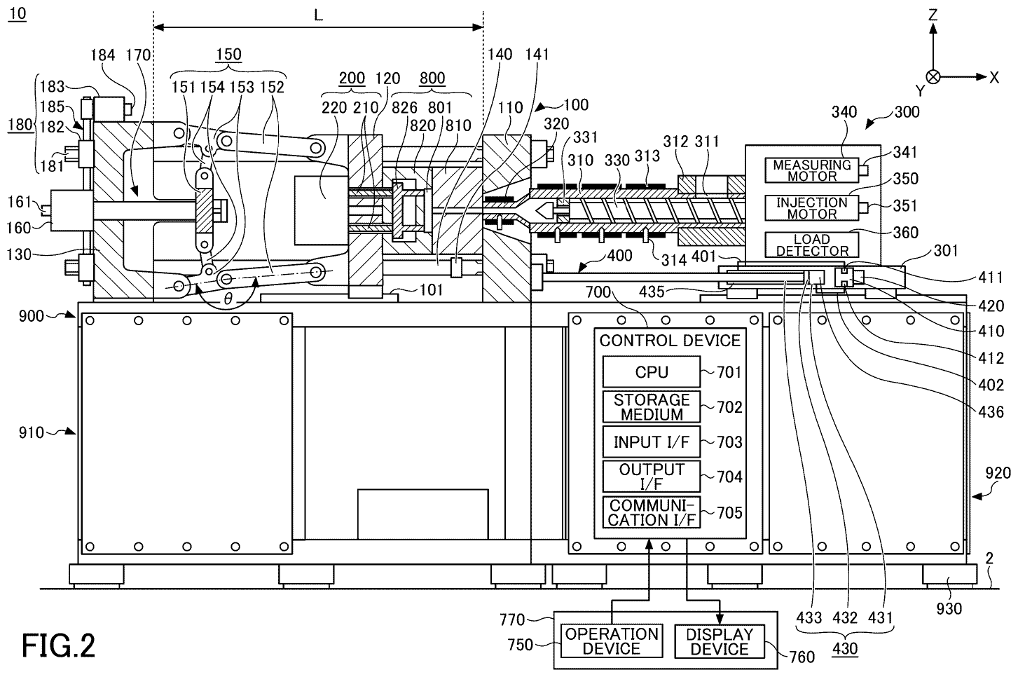

FIG. 1 is a diagram illustrating a state when mold opening of an injection molding machine according to an embodiment is completed. FIG. 2 is a diagram illustrating a state when a mold of the injection molding machine according to the embodiment is clamped. In the present specification, an X-axis direction, a Y-axis direction, and a Z-axis direction are directions perpendicular to each other. The X-axis direction and the Y-axis direction represent a horizontal direction, and the Z-axis direction represents a vertical direction. When a mold clamping device 100 is a horizontal type, the X-axis direction is a mold opening-closing direction, and the Y-axis direction is a width direction of an injection molding machine 10. A negative side in the Y-axis direction is called an operating side, and a positive side in the Y-axis direction is called an anti-operating side.

As illustrated in FIGS. 1 and 2, the injection molding machine 10 includes the mold clamping device 100 that opens and closes a mold device 800, an ejector device 200 that ejects a molded product molded by the mold device 800, an injection device 300 that injects a molding material into the mold device 800, a moving device 400 that advances and retracts the injection device 300 with respect to the mold device 800, a control device 700 that controls each component of the injection molding machine 10, and a frame 900 that supports each component of the injection molding machine 10. The frame 900 includes a mold clamping device frame 910 that supports the mold clamping device 100 and an injection device frame 920 that supports the injection device 300. The mold clamping device frame 910 and the injection device frame 920 are installed on the floor 2 via and, respective leveling adjusters 930. The control device 700 is disposed in an internal space of the injection device frame 920. Hereinafter, each component of the injection molding machine 10 will be described.

### (Clamping Device)

In the description of the mold clamping device 100, a moving direction (for example, an X-axis positive direction) of a movable platen 120 when the mold is closed is referred to as a front side, and a moving direction (for example, an X-axis negative direction) of the movable platen 120 when the mold is opened is referred to as a rear side.

The mold clamping device 100 performs closing, pressurizing, clamping, depressurizing, and opening of the mold device 800. The mold device 800 includes a fixed mold 810 and a movable mold 820. The mold clamping device 100 is, for example, a horizontal type, and the mold opening-closing direction is a horizontal direction. The mold clamping device 100 includes a stationary platen 110 to which the fixed mold 810 is attached, a movable platen 120 to which the movable mold 820 is attached, and a moving mechanism 102 that moves the movable platen 120 in the mold opening-closing direction with respect to the stationary platen 110.

The stationary platen 110 is fixed to the mold clamping device frame 910. The fixed mold 810 is attached to a surface of the stationary platen 110 facing the movable platen 120.

The movable platen 120 is disposed so as to be movable in the mold opening-closing direction with respect to the mold clamping device frame 910. A guide 101 for guiding the movable platen 120 is laid on the mold clamping device frame 910. A movable mold 820 is attached to a surface of the movable platen 120 facing the stationary platen 110.

The moving mechanism 102 advances and retracts the movable platen 120 with respect to the stationary platen 110 to perform closing, pressurizing, clamping, depressurizing, and opening of the mold device 800. The moving mechanism 102 includes a toggle support 130 disposed at a distance from the stationary platen 110, a tie bar 140 connecting the stationary platen 110 and the toggle support 130, a toggle mechanism 150 moving the movable platen 120 in the mold opening-closing direction with respect to the toggle support 130, a mold clamping motor 160 operating the toggle mechanism 150, a motion conversion mechanism 170 converting the rotational motion of the mold clamping motor 160 into linear motion, and a mold thickness adjustment mechanism 180 adjusting the distance between the stationary platen 110 and the toggle support 130.

The toggle support 130 is disposed with a space from the stationary platen 110 and is placed on the mold clamping device frame 910 so as to be movable in the mold opening-closing direction. The toggle support 130 may be disposed so as to be movable along a guide laid on the mold clamping device frame 910. The guide of the toggle support 130 may be common to the guide 101 of the movable platen 120.

In the present embodiment, the stationary platen 110 is fixed to the mold clamping device frame 910, and the toggle support 130 is disposed so as to be movable in the mold opening-closing direction with respect to the mold clamping device frame 910, but the toggle support 130 may be fixed to the mold clamping device frame 910, and the stationary platen 110 may be disposed so as to be movable in the mold opening-closing direction with respect to the mold clamping device frame 910.

The tie bar 140 connects the stationary platen 110 and the toggle support 130 with a space L in the mold opening-closing direction. A plurality of (for example, four) tie bars 140 may be used. The plurality of tie bars 140 are arranged in parallel in the mold opening-closing direction and extend according to the mold clamping force. A tie bar strain detector 141 for detecting strain of the tie bar 140 may be provided on at least one tie bar 140. The tie bar strain detector 141 sends a signal indicating the detection result to the control device 700. The detection result of the tie bar strain detector 141 is used for detection of the mold clamping force and the like.

In the present embodiment, the tie bar strain detector 141 is used as a mold clamping force detector that detects the mold clamping force, but the present disclosure is not limited thereto. The mold clamping force detector is not limited to a strain gauge type, and may be a piezoelectric type, a capacitance type, a hydraulic type, an electromagnetic type, or the like, and the attachment position thereof is not limited to the tie bar 140.

The toggle mechanism 150 is disposed between the movable platen 120 and the toggle support 130, and moves the movable platen 120 in the mold opening-closing direction with respect to the toggle support 130. The toggle mechanism 150 includes a crosshead 151 that moves in the mold opening-closing direction, and a pair of link groups that bend and extend by the movement of the crosshead 151. The pair of link groups each include a first link 152 and a second link 153 which are connected to each other by a pin or the like so as to be bendable and extendable. The first link 152 is attached to the movable platen 120 by a pin or the like so as to be swingable. The second link 153 is swingably attached to the toggle support 130 by a pin or the like. The second link 153 is attached to the crosshead 151 via a third link 154. When the crosshead 151 advances and retracts with respect to the toggle support 130, the first link 152 and the second link 153 are bent and extended, and the movable platen 120 advances and retracts with respect to the toggle support 130.

The configuration of the toggle mechanism 150 is not limited to the configuration illustrated in FIGS. 1 and 2. For example, in FIGS. 1 and 2, the number of nodes of each link group is five, but may be four, and one end of the third link 154 may be coupled to the node between the first link 152 and the second link 153.

The mold clamping motor 160 is attached to the toggle support 130 and operates the toggle mechanism 150. The mold clamping motor 160 advances and retracts the crosshead 151 with respect to the toggle support 130 to bend and extend the first link 152 and the second link 153, and advances and retracts the movable platen 120 with respect to the toggle support 130. The mold clamping motor 160 is directly connected to the motion conversion mechanism 170, but may be connected to the motion conversion mechanism 170 via a belt, a pulley, or the like.

The motion conversion mechanism 170 converts the rotational motion of the mold clamping motor 160 into the linear motion of the crosshead 151. The motion conversion mechanism 170 includes a screw shaft and a screw nut screwed to the screw shaft. Balls or rollers may be interposed between the screw shaft and the screw nut.

The mold clamping device 100 performs a mold closing step, a pressurizing step, a mold clamping step, a depressurizing step, a mold opening step, and the like under the control of the control device 700.

In the mold closing step, the mold clamping motor 160 is driven to advance the crosshead 151 to a mold closing completion position at a set movement speed, thereby advancing the movable platen 120 and causing the movable mold 820 to touch the fixed mold 810. The position and the moving speed of the crosshead 151 are detected by using, for example, a mold clamping motor encoder 161. The mold clamping motor encoder 161 detects the rotation of the mold clamping motor 160 and sends a signal indicating the detection result to the control device 700.

The crosshead position detector that detects the position of the crosshead 151 and the crosshead movement speed detector that detects the movement speed of the crosshead 151 are not limited to the mold clamping motor encoder 161, and general detectors may be used. Further, the movable platen position detector for detecting the position of the movable platen 120 and the movable platen moving speed detector for detecting the moving speed of the movable platen 120 are not limited to the mold clamping motor encoder 161, and general detectors can be used.

In the pressurizing step, the mold clamping force is generated by further driving the mold clamping motor 160 to further advance the crosshead 151 from the mold closing completion position to the mold clamping position.

In the mold clamping step, the mold clamping motor 160 is driven to maintain the position of the crosshead 151 at the mold clamping position. In the mold clamping step, the mold clamping force generated in the pressurizing step is maintained. In the mold clamping step, a cavity space 801 (see FIG. 2) is formed between the movable mold 820 and the fixed mold 810, and the injection device 300 fills the cavity space 801 with a liquid molding material. The filled molding material is solidified to obtain a molded product.

The number of cavity spaces 801 may be one or more. In the latter case, a plurality of molded products are obtained simultaneously. An insert material may be disposed in a part of the cavity space 801, and a molding material may be filled in another part of the cavity space 801. A molded product in which the insert material and the molding material are integrated is obtained.

In the depressurizing step, the movable platen 120 is retracted by driving the mold clamping motor 160 to retract the crosshead 151 from the mold clamping position to the mold opening start position, and the mold clamping force is reduced. The mold opening start position and the mold closing completion position may be the same position.

In the mold opening step, the movable platen 120 is retracted by driving the mold clamping motor 160 to retract the crosshead 151 from the mold opening start position to the mold opening completion position at a set movement speed, and the movable mold 820 is separated from the fixed mold 810. Thereafter, the ejector device 200 ejects the molded product from the movable mold 820.

The setting conditions in the mold closing step, the pressurizing step, and the mold clamping step are collectively set as a series of setting conditions. For example, the movement speed and position (including the mold closing start position, movement speed switching position, mold closing completion position, and mold clamping position) of the crosshead 151 in the mold closing step and the pressurizing step, and the mold clamping force are collectively set as a series of setting conditions. The mold closing start position, the moving speed switching position, the mold closing completion position, and the mold clamping position are arranged in this order from the rear side to the front side, and represent a start point and an end point of a section in which the moving speed is set. A moving speed is set for each section. The number of the moving speed switching positions may be one or more. The moving speed switching position may not be set. Only one of the mold clamping position and the mold clamping force may be set.

The setting conditions in the depressurizing step and the mold opening step are set in the same manner. For example, the movement speed and the position (the mold opening start position, the movement speed switching position, and the mold opening completion position) of the crosshead 151 in the depressurizing step and the mold opening step are collectively set as a series of setting conditions. The mold opening start position, the movement speed switching position, and the mold opening completion position are arranged in this order from the front side to the rear side, and represent a start point and an end point of a section in which the movement speed is set. A moving speed is set for each section. The number of the moving speed switching positions may be one or more. The moving speed switching position may not be set. The mold opening start position and the mold closing completion position may be the same position. The mold opening completion position and the mold closing start position may be the same position.

Instead of the moving speed and the position of the crosshead 151, the moving speed and the position of the movable platen 120 may be set. Further, instead of the position of the crosshead (for example, the mold clamping position) or the position of the movable platen, the mold clamping force may be set.

The toggle mechanism 150 amplifies the driving force of the mold clamping motor 160 and transmits the amplified driving force to the movable platen 120. The amplification factor is also called a toggle factor. The toggle magnification changes according to an angle θ formed by the first link 152 and the second link 153 (hereinafter, also referred to as a “link angle A”). The link angle θ is obtained from the position of the crosshead 151. When the link angle θ is 180°, the toggle magnification is the largest.

When the thickness of the mold device 800 changes due to the replacement of the mold device 800 or a change in the temperature of the mold device 800, the mold thickness is adjusted so that a predetermined mold clamping force is obtained when the mold is clamped. In the mold thickness adjustment, for example, the space L between the stationary platen 110 and the toggle support 130 is adjusted so that the link angle θ of the toggle mechanism 150 becomes a predetermined angle at the time of mold touch when the movable mold 820 touches the fixed mold 810.

The mold clamping device 100 includes a mold thickness adjustment mechanism 180. The mold thickness adjustment mechanism 180 adjusts the mold thickness by adjusting the space L between the stationary platen 110 and the toggle support 130. The mold thickness adjustment is performed, for example, between the end of a molding cycle and the start of the next molding cycle. The mold thickness adjustment mechanism 180 includes, for example, a screw shaft 181 formed at the rear end of the tie bar 140, a screw nut 182 held by the toggle support 130 so as to be rotatable and not to advance and retract, and a mold thickness adjustment motor 183 that rotates the screw nut 182 screwed to the screw shaft 181.

The screw shaft 181 and the screw nut 182 are provided for each tie bar 140. The rotational driving force of the mold thickness adjustment motor 183 may be transmitted to the plurality of screw nuts 182 via a rotational driving force transmission unit 185. The plurality of screw nuts 182 can be rotated synchronously. Note that the plurality of screw nuts 182 can be individually rotated by changing the transmission path of the rotational driving force transmission unit 185.

The rotational driving force transmission unit 185 is configured by, for example, a gear. In this case, a driven gear is formed on the outer periphery of each screw nuts 182, a driving gear is attached to the output shaft of the mold thickness adjustment motor 183, and an intermediate gear which meshes with the plurality of driven gears and the driving gear is rotatably held at the center of the toggle support 130. The rotational driving force transmission unit 185 may be configured by a belt, a pulley, or the like instead of the gear.

The operation of the mold thickness adjustment mechanism 180 is controlled by the control device 700. The control device 700 drives the mold thickness adjustment motor 183 to rotate the screw nuts 182. As a result, the position of the toggle support 130 with respect to the tie bar 140 is adjusted, and the space L between the stationary platen 110 and the toggle support 130 is adjusted. A plurality of mold thickness adjustment mechanisms may be used in combination.

The space L is detected by using a mold thickness adjustment motor encoder 184. The mold thickness adjustment motor encoder 184 detects the rotation amount and the rotation direction of the mold thickness adjustment motor 183, and sends a signal indicating the detection result to the control device 700. The detection result of the mold thickness adjustment motor encoder 184 is used for monitoring and controlling the position of the toggle support 130 and the space L. The toggle support position detector for detecting the position of the toggle support 130 and the interval detector for detecting the space L are not limited to the mold thickness adjustment motor encoder 184, and general detectors can be used.

The mold clamping device 100 may include a mold temperature regulator that regulates the temperature of the mold device 800. The mold device 800 has a flow path for a temperature control medium in the mold device 800. The mold temperature regulator regulates the temperature of the mold device 800 by regulating the temperature of the temperature regulating medium supplied to the flow path of the mold device 800.

The mold clamping device 100 of the present embodiment is a horizontal type in which the mold opening-closing direction is a horizontal direction, but may be a vertical type in which the mold opening-closing direction is a vertical direction.

The mold clamping device 100 of the present embodiment includes the mold clamping motor 160 as a drive source, but may include a hydraulic cylinder instead of the mold clamping motor 160. The mold clamping device 100 may include a linear motor for opening and closing the mold and an electromagnet for clamping the mold.

### (Ejector Device)

In the description of the ejector device 200, as in the description of the mold clamping device 100, the movement direction (for example, the X-axis positive direction) of the movable platen 120 when the mold is closed is described as the front, and the movement direction (for example, the X-axis negative direction) of the movable platen 120 when the mold is opened is described as the rear.

The ejector device 200 is attached to the movable platen 120 and advances and retracts together with the movable platen 120. The ejector device 200 includes an ejector rod 210 that ejects a molded product from the mold device 800, and a drive mechanism 220 that moves the ejector rod 210 in the moving direction (X-axis direction) of the movable platen 120.

The ejector rod 210 is disposed in a through-hole of the movable platen 120 so as to advance and retract. The front end of the ejector rod 210 is in contact with an ejector plate 826 of the movable mold 820. The front end of the ejector rod 210 may be connected to the ejector plate 826 or may not be connected to the ejector plate 826.

The drive mechanism 220 includes, for example, an ejector motor and a motion conversion mechanism that converts a rotational motion of the ejector motor into a linear motion of the ejector rod 210. The motion conversion mechanism includes a screw shaft and a screw nut screwed to the screw shaft. Balls or rollers may be interposed between the screw shaft and the screw nut.

The ejector device 200 performs the ejection step under the control of the control device 700. In the ejection step, the ejector rod 210 is moved forward from the standby position to the ejection position at a set moving speed, whereby the ejector plate 826 is moved forward to eject the molded product. Thereafter, the ejector motor is driven to move the ejector rod 210 backward at a set moving speed, and the ejector plate 826 is moved backward to the original standby position.

The position and the moving speed of the ejector rod 210 are detected by using, for example, an ejector motor encoder. The ejector motor encoder detects the rotation of the ejector motor and sends a signal indicating the detection result to the control device 700. The ejector rod position detector for detecting the position of the ejector rod 210 and the ejector rod moving speed detector for detecting the moving speed of the ejector rod 210 are not limited to the ejector motor encoder, and general detectors can be used.

### (Injection Device)

In the description of the injection device 300, unlike the description of the mold clamping device 100 and the description of the ejector device 200, the movement direction of the screw 330 during filling (for example, the X-axis negative direction) is referred to as the front side, and the movement direction of the screw 330 during measuring (for example, the X-axis positive direction) is referred to as the rear side.

The injection device 300 is installed on a slide base 301, and the slide base 301 is disposed so as to advance and retract with respect to an injection device frame 920. The injection device 300 is disposed so as to advance and retract with respect to the mold device 800. The injection device 300 touches the mold device 800 and fills the cavity space 801 in the mold device 800 with the molding material measured in the cylinder 310. The injection device 300 includes, for example, a cylinder 310 that heats the molding material, a nozzle 320 provided at a front end of the cylinder 310, a screw 330 disposed in the cylinder 310 so as to advance and retract and that is rotatable, a measuring motor 340 that rotates the screw 330, an injection motor 350 that advances and retracts the screw 330, and a load detector 360 that detects a load transmitted between the injection motor 350 and the screw 330.

The cylinder 310 heats the molding material supplied from a supply port 311 to the inside. The molding material includes, for example, a resin. The molding material is formed in a pellet shape, for example, and is supplied to the supply port 311 in a solid state. The supply port 311 is formed in a rear portion of the cylinder 310. A cooler 312 such as a water-cooled cylinder is provided on the outer periphery of the rear portion of the cylinder 310. A heater 313 such as a band heater and a temperature detector 314 are provided on the outer periphery of the cylinder 310 in front of the cooler 312.

The cylinder 310 is divided into a plurality of zones in the axial direction (for example, the X-axis direction) of the cylinder 310. The heater 313 and the temperature detector 314 are provided in each of the plurality of zones. A set temperature is set for each of the plurality of zones, and the control device 700 controls the heater 313 so that the temperature detected by the temperature detector 314 becomes the set temperature.

The nozzle 320 is provided at the front end of the cylinder 310 and is pressed against the mold device 800. A heater 313 and a temperature detector 314 are provided on the outer periphery of the nozzle 320. The control device 700 controls the heater 313 so that the detected temperature of the nozzle 320 becomes the set temperature.

The screw 330 is disposed in the cylinder 310 so as to be rotatable and retractable. When the screw 330 is rotated, the molding material is fed forward along the spiral groove of the screw 330. The molding material is gradually melted by the heat from the cylinder 310 while being fed forward. As the liquid molding material is fed to the front of the screw 330 and accumulated in the front portion of the cylinder 310, the screw 330 is moved backward. Thereafter, when the screw 330 is advanced, the liquid molding material accumulated in front of the screw 330 is injected from the nozzle 320 and is filled into the mold device 800.

A backflow prevention ring 331 is attached to the front portion of the screw 330 so as to be retractable as a backflow prevention valve that prevents backflow of the molding material from the front side to the rear side of the screw 330 when the screw 330 is pushed forward.

When the screw 330 is advanced, the backflow prevention ring 331 is pushed rearward by the pressure of the molding material in front of the screw 330, and is retracted relative to the screw 330 to a closing position (see FIG. 2) at which the flow path of the molding material is closed. This prevents the molding material accumulated in front of the screw 330 from flowing backward.

On the other hand, when the screw 330 is rotated, the backflow prevention ring 331 is pushed forward by the pressure of the molding material fed forward along the spiral groove of the screw 330, and moves forward relative to the screw 330 to an open position (see FIG. 1) at which the flow path of the molding material is opened. Thus, the molding material is fed to the front of the screw 330.

The backflow prevention ring 331 may be either a co-rotation type that rotates together with the screw 330 or a non-co-rotation type that does not rotate together with the screw 330.

The injection device 300 may include a drive source that advances and retracts the backflow prevention ring 331 between the open position and the closed position with respect to the screw 330.

The measuring motor 340 rotates the screw 330. The drive source for rotating the screw 330 is not limited to the measuring motor 340, and may be, for example, a hydraulic pump.

The injection motor 350 advances and retracts the screw 330. A motion conversion mechanism or the like for converting the rotational motion of the injection motor 350 into the linear motion of the screw 330 is provided between the injection motor 350 and the screw 330. The motion conversion mechanism includes, for example, a screw shaft and a screw nut screwed to the screw shaft. Balls, rollers, or the like may be provided between the screw shaft and the screw nut. The drive source for advancing and retracting the screw 330 is not limited to the injection motor 350, and may be, for example, a hydraulic cylinder.

The load detector 360 detects a load transmitted between the injection motor 350 and the screw 330. The detected load is converted into a pressure by the control device 700. The load detector 360 is provided in a load transmission path between the injection motor 350 and the screw 330, and detects a load acting on the load detector 360.

The load detector 360 sends a signal of the detected load to the control device 700. The load detected by the load detector 360 is converted into a pressure acting between the screw 330 and the molding material, and is used for controlling or monitoring a pressure received by the screw 330 from the molding material, a back pressure to the screw 330, a pressure acting on the molding material from the screw 330, and the like.

The pressure detector for detecting the pressure of the molding material is not limited to the load detector 360, and a general pressure detector can be used. For example, a nozzle pressure sensor or a mold internal pressure sensor may be used. The nozzle pressure sensor is installed in the nozzle 320.

The injection device 300 performs a measuring step, a filling step, a packing pressure step, and the like under the control of the control device 700. The filling step and the packing pressure step may be collectively referred to as an injection step.

In the measuring step, the measuring motor 340 is driven to rotate the screw 330 at a set rotation speed, and the molding material is fed forward along the spiral groove of the screw 330. Accordingly, the molding material is gradually melted. As the liquid molding material is fed to the front of the screw 330 and accumulated in the front portion of the cylinder 310, the screw 330 is moved backward. The rotation speed of the screw 330 is detected by using, for example, the measuring motor encoder 341. The measuring motor encoder 341 detects the rotation of the measuring motor 340 and sends a signal indicating the detection result to the control device 700. The screw rotational speed detector for detecting the rotational speed of the screw 330 is not limited to the measuring motor encoder 341, and a general detector can be used.

In the measuring step, in order to limit the rapid retraction of the screw 330, the injection motor 350 may be driven to apply a setback pressure to the screw 330. The back pressure to the screw 330 is detected by using, for example, the load detector 360. When the screw 330 retracts to the measuring completion position and a predetermined amount of the molding material is accumulated in front of the screw 330, the measuring step is completed.

The position and the rotation speed of the screw 330 in the measuring step are collectively set as a series of setting conditions. For example, a measurement start position, a rotational speed switching position, and a measurement completion position are set. These positions are arranged in this order from the front side to the rear side, and represent the start point and the end point of the section in which the rotation speed is set. The rotation speed is set for each section. The rotational speed switching position may be one or more. The rotational speed switching position may not be set. Further, the back pressure is set for each section.

In the filling step, the injection motor 350 is driven to move the screw 330 forward at a set moving speed, and the liquid molding material accumulated in front of the screw 330 is filled in the cavity space 801 in the mold device 800. The position and the moving speed of the screw 330 are detected by using, for example, the injection motor encoder 351. The injection motor encoder 351 detects the rotation of the injection motor 350, and sends a signal indicating the detection result to the control device 700. When the position of the screw 330 reaches the set position, switching from the filling step to the packing pressure step (so-called V/P switching) is performed. The position where the V/P switching is performed is also referred to as a V/P switching position. The set moving speed of the screw 330 may be changed according to the position of the screw 330, time, or the like.

The position and the moving speed of the screw 330 in the filling step are collectively set as a series of setting conditions. For example, the filling start position (also referred to as “injection start position”) is set. The moving speed switching position and the V/P switching position are set. These positions are arranged in this order from the rear side to the front side and represent the start point and the end point of the section in which the moving speed is set. A moving speed is set for each section. The number of the moving speed switching positions may be one or more. The moving speed switching position may not be set.

The upper limit value of the pressure of the screw 330 is set for each section in which the moving speed of the screw 330 is set. The pressure of the screw 330 is detected by the load detector 360. When the pressure of the screw 330 is equal to or lower than the set pressure, the screw 330 is moved forward at the set moving speed. On the other hand, when the pressure of the screw 330 exceeds the set pressure, the screw 330 is advanced at a moving speed lower than the set moving speed so that the pressure of the screw 330 becomes equal to or lower than the set pressure for the purpose of protecting the mold.

Note that, after the position of the screw 330 reaches the V/P switching position in the filling step, the screw 330 may be temporarily stopped at the V/P switching position, and then the V/P switching may be performed. Immediately before the V/P switching, the screw 330 may be advanced or retracted at a very low speed instead of stopping the screw 330. Further, the screw position detector for detecting the position of the screw 330 and the screw moving speed detector for detecting the moving speed of the screw 330 are not limited to the injection motor encoder 351, and general detectors can be used.

In the packing pressure step, the injection motor 350 is driven to push the screw 330 forward, and the pressure of the molding material at the front end of the screw 330 (hereinafter, also referred to as “holding pressure”) is increased. The molding material remaining in the cylinder 310 is pushed toward the mold device 800. The molding material can be replenished for the shortage due to cooling shrinkage in the mold device 800. The holding pressure is detected by using, for example, the load detector 360. The set value of the holding pressure may be changed according to the elapsed time from the start of the packing pressure step. A plurality of holding pressures and a plurality of holding times for holding the holding pressures in the packing pressure step may be set, and may be collectively set as a series of setting conditions.

In the packing pressure step, the molding material in the cavity space 801 in the mold device 800 is gradually cooled, and when the packing pressure step is completed, the inlet of the cavity space 801 is closed by the solidified molding material. This state is called a gate seal, and the backflow of the molding material from the cavity space 801 is prevented. After the packing pressure step, the cooling step starts. In the cooling step, the molding material in the cavity space 801 is solidified. In order to shorten the molding cycle time, the measuring step may be performed during the cooling step.

The injection device 300 of the present embodiment is of an in-line screw type, but may be of a pre-plasticizing type or the like. The pre-plasticizing injection device supplies a molding material melted in a plasticizing cylinder to an injection cylinder, and injects the molding material from the injection cylinder into a mold device. The screw is arranged in the plasticizing cylinder in a rotatable and non-retractable manner, or the screw is arranged in a rotatable and retractable manner. On the other hand, a plunger is disposed in the injection cylinder in a retractable manner.

Further, the injection device 300 of the present embodiment is a horizontal type in which the axial direction of the cylinder 310 is the horizontal direction, but may be a vertical type in which the axial direction of the cylinder 310 is the vertical direction. The mold clamping device combined with the vertical injection device 300 may be a vertical type or a horizontal type. Similarly, the mold clamping device combined with the horizontal injection device 300 may be horizontal type or vertical type.

### (Moving Device)

In the description of the moving device 400, as in the description of the injection device 300, the moving direction (for example, the X-axis negative direction) of the screw 330 during filling is referred to as the front side, and the moving direction (for example, the X-axis positive direction) of the screw 330 during measuring is referred to as the rear side.

The moving device 400 advances and retracts the injection device 300 with respect to the mold device 800. The moving device 400 presses the nozzle 320 against the mold device 800 to generate a nozzle touch pressure. The moving device 400 includes a hydraulic pump 410, a motor 420 as a drive source, a hydraulic cylinder 430 as a hydraulic actuator, and the like.

The hydraulic pump 410 has a first port 411 and a second port 412. The hydraulic pump 410 is a pump capable of rotating in both directions, and generates a hydraulic pressure by switching the rotation direction of the motor 420 to suck a working fluid (for example, oil) from one of the first port 411 or the second port 412 and discharge the working fluid from the other one of the first port 411 or the second port 412. The hydraulic pump 410 can also suck the working fluid from the tank and discharge the working fluid from either the first port 411 or the second port 412.

The motor 420 operates the hydraulic pump 410. The motor 420 drives the hydraulic pump 410 in a rotational direction and with a rotational torque corresponding to a control signal from the control device 700. The motor 420 may be an electric motor or an electric servo motor.

The hydraulic cylinder 430 includes a cylinder body 431, a piston 432, and a piston rod 433. The cylinder body 431 is fixed to the injection device 300. The piston 432 divides the inside of the cylinder body 431 into a front chamber 435 as a first chamber and a rear chamber 436 as a second chamber. The piston rod 433 is fixed relative to the stationary platen 110.

The front chamber 435 of the hydraulic cylinder 430 is connected to the first port 411 of the hydraulic pump 410 via the first flow path 401. The working fluid discharged from the first port 411 is supplied to the front chamber 435 via the first flow path 401, and thus the injection device 300 is pushed forward. The injection device 300 is advanced, and the nozzle 320 is pressed against the fixed mold 810. The front chamber 435 functions as a pressure chamber that generates a nozzle touch pressure of the nozzle 320 by the pressure of the working liquid supplied from the hydraulic pump 410.

On the other hand, the rear chamber 436 of the hydraulic cylinder 430 is connected to the second port 412 of the hydraulic pump 410 via a second flow path 402. The hydraulic fluid discharged from the second port 412 is supplied to the rear chamber 436 of the hydraulic cylinder 430 via the second flow path 402, whereby the injection device 300 is pushed rearward. The injection device 300 is retracted, and the nozzle 320 is separated from the fixed mold 810.

In the present embodiment, the moving device 400 includes the hydraulic cylinder 430, but the present disclosure is not limited thereto. For example, instead of the hydraulic cylinder 430, an electric motor and a motion conversion mechanism that converts the rotational motion of the electric motor into the linear motion of the injection device 300 may be used.

### (Control Device)

The control device 700 is configured by, for example, a computer, and includes circuitry, or a central processing unit (CPU) 701, a storage medium 702 such as a memory, an input interface 703, an output interface 704, and a communication interface (I/F) 705 as illustrated in FIGS. 1 and 2. The control device 700 performs various controls by causing the CPU 701 to execute the program stored in the storage medium 702. The control device 700 receives a signal from the outside through the input interface 703 and transmits a signal to the outside through the output interface 704.

The control device 700 repeatedly performs the measuring step, the mold closing step, the pressurizing step, the mold clamping step, the filling step, the pressure holding process, the cooling process, the depressurizing process, the mold opening step, the ejection step, and the like, and thus repeatedly produces the molded product. A series of operations for obtaining a molded product, for example, an operation from the start of a measuring step to the start of the next measuring step is also referred to as a “shot” or a “molding cycle.” The time required for one shot is also referred to as “molding cycle time” or “cycle time.”

One molding cycle includes, for example, a measuring step, a mold closing step, a pressurizing step, a mold clamping step, a filling step, a packing pressure step, a cooling step, a depressurizing step, a mold opening step, and an ejection step in this order. The order here is the order of the start of each step. The filling step, the packing pressure step, and the cooling step are performed during the mold clamping step. The start of the mold clamping step may match the start of the filling step. The completion of the depressurizing step matches the start of the mold opening step.

A plurality of steps may be performed simultaneously for the purpose of shortening the molding cycle time. For example, the measuring step may be performed during the cooling step of the previous molding cycle, or may be performed during the mold clamping step. In this case, the mold closing step may be performed at the start of the molding cycle. The filling step may start during the mold closing step. The ejection step may start during the mold opening step. In a case where an opening-closing valve that opens and closes the flow path of the nozzle 320 is provided, the mold opening step may start during the measuring step. This is because even if the mold opening step starts during the measuring step, the molding material does not leak from the nozzle 320 as long as the on-off valve closes the flow path of the nozzle 320.

One molding cycle may include a step other than the measuring step, the mold closing step, the pressurizing step, the mold clamping step, the filling step, the packing pressure step, the cooling process, the depressurizing step, the mold opening step, and the ejection step.

For example, after the completion of the packing pressure step, before the start of the measuring step, a pre-measuring suck back process of retracting the screw 330 to a predetermined measuring start position may be performed. The pressure of the molding material accumulated in front of the screw 330 before the start of the measuring step can be reduced, and the rapid retraction of the screw 330 at the start of the measuring step can be prevented.

After the completion of the measuring step and before the start of the filling step, the screw 330 is moved to a preset filling start position (also referred to as an “injection start position”). The suck-back step may be performed after the measurement. The pressure of the molding material accumulated in front of the screw 330 before the start of the filling step can be reduced, and the leakage of the molding material from the nozzle 320 before the start of the filling step can be prevented.

The control device 700 is connected to an operation device 750 that receives an input operation by a user and a display device 760 that displays a screen. The operation device 750 and the display device 760 may be configured by, for example, a touch panel 770 and may be integrated. The touch panel 770 as the display device 760 displays a screen under the control of the control device 700. For example, information such as the setting of the injection molding machine 10 and the current state of the injection molding machine 10 may be displayed on the screen of the touch panel 770. The touch panel 770 can receive an operation in a displayed screen area. In addition, for example, an operation unit such as a button or an input field for receiving an input operation by the user may be displayed in the screen region of the touch panel 770. The touch panel 770 as the operation device 750 detects an input operation on the screen by the user and outputs a signal corresponding to the input operation to the control device 700. Thus, for example, the user can perform setting (including input of a setting value) of the injection molding machine 10 by operating the operation unit provided on the screen while checking the information displayed on the screen. Further, the user can operate the operation unit provided on the screen to cause the injection molding machine 10 to perform an operation corresponding to the operation unit. Note that the operation of the injection molding machine 10 may be, for example, the operation (including stopping) of the mold clamping device 100, the ejector device 200, the injection device 300, the moving device 400, or the like. The operation of the injection molding machine 10 may be switching of a screen displayed on the touch panel 770 as the display device 760.

Note that the operation device 750 and the display device 760 of the present embodiment are described as being integrated as the touch panel 770, but may be provided independently. A plurality of operation devices 750 may be provided. The operation device 750 and the display device 760 are disposed on the operation side (Y-axis negative direction) of the mold clamping device 100 (more specifically, the stationary platen 110).

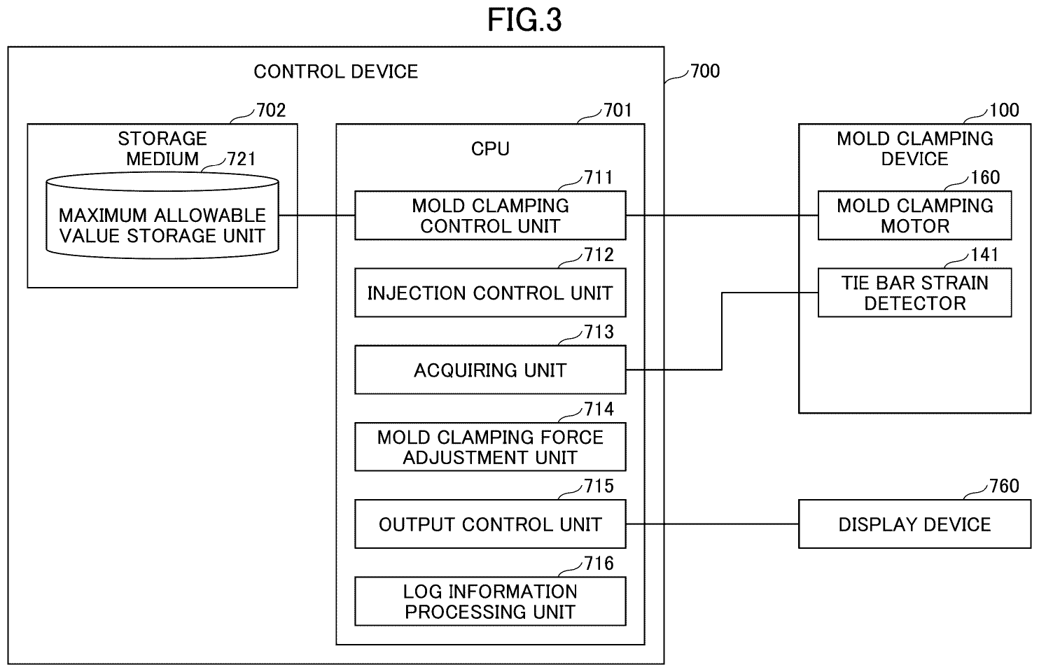

FIG. 3 is a diagram illustrating an example of a functional configuration of the control device 700 according to the present embodiment. As illustrated in FIG. 3, the constituent elements of the control device 700 of the injection molding machine 10 are illustrated by functional blocks. Each functional block illustrated in FIG. 3 is conceptual, and is not necessarily physically configured as illustrated in the figure. All or some of the functional blocks may be configured to be functionally or physically distributed or integrated in arbitrary units. All or any part of the processing functions performed by the functional blocks are implemented by a program executed in the CPU 701. Alternatively, each functional block may be implemented as hardware by wired logic. As illustrated in FIG. 3, the CPU 701 of the control device 700 includes, for example, a mold clamping control unit 711, an injection control unit 712, an acquiring unit 713, an adjustment unit 714, an output control unit 715, and a log information processing unit 716. The storage medium 702 of the control device 700 includes a maximum allowable value storage unit 721.

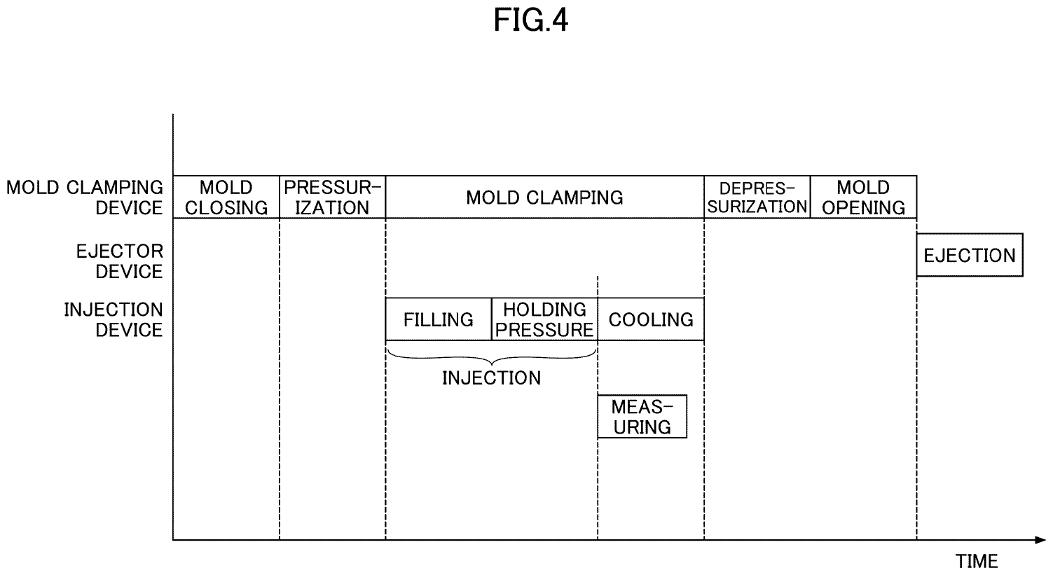

The mold clamping control unit 711 controls the mold clamping drive source of the mold clamping device 100 to perform a mold closing step, a pressurizing step, a mold clamping step, a depressurizing step, and a mold opening step illustrated in FIG. 4. The mold clamping drive source is, for example, the mold clamping motor 160, but may be a hydraulic cylinder or the like.

The injection control unit 712 controls the injection drive source of the injection device 300 to perform the injection step. The injection drive source is, for example, the injection motor 350, but may be a hydraulic cylinder or the like. The injection step includes a filling step and a packing pressure step. The injection step is performed during the mold clamping step.

The filling step is a step of controlling the injection drive source so that the actual value of the moving speed of the injection member provided inside the cylinder 310 becomes a set value. The filling step is a step of filling the inside of the mold device 800 with the liquid molding material accumulated in front of the injection member by moving the injection member forward. The injection member is, for example, the screw 330 (see FIGS. 1 and 2), but may be a plunger.

The moving speed of the injection member is detected by using a speed detector. The speed detector is, for example, the injection motor encoder 351. In the filling step, the injection member is advanced, whereby a pressure (hereinafter, also referred to as a “filling pressure”) applied from the injection member to the molding material is increased. The filling step may include a step of temporarily stopping the injection member or a step of retracting the injection member immediately before the packing pressure step.

The packing pressure step is a step of controlling the injection drive source so that the actual value of the filling pressure becomes a set value. The packing pressure step is a step of replenishing the molding material for shortage due to cooling shrinkage in the mold device 800 by pushing the injection member forward. The filling pressure is detected by using a pressure detector such as the load detector 360. As the pressure detector, a nozzle pressure sensor or a mold internal pressure sensor may be used.

The injection step is performed during the mold clamping step as described above. The mold clamping control unit 711 converts, for example, a set value of the mold clamping force into a set value of the crosshead position, and controls the mold clamping motor 160 so that an actual value of the crosshead position becomes the set value. The crosshead position is a relative position of the crosshead 151 (see FIG. 2) with respect to the toggle support 130. The mold clamping force increases as the crosshead 151 advances.

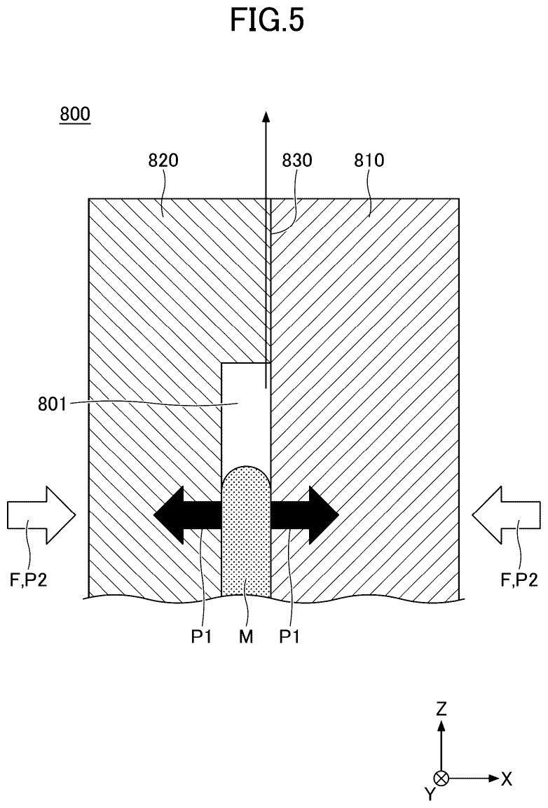

Next, an example of a molding material M flowing into the mold device 800 will be described with reference to FIG. 5. The molding material M is, for example, a resin. The molding material M flows into the cavity space 801 inside the mold device 800. The cavity space 801 is formed on the parting surfaces 830 of the fixed mold 810 and the movable mold 820. The parting surfaces 830 is generally called a parting line.

The molding material M is injected by the injection device 300, and then flows into the cavity space 801 formed between the fixed mold 810 and the movable mold 820 through a sprue (not illustrated) of the fixed mold 810. Until the flow front of the molding material M reaches the parting surfaces 830 between the fixed mold 810 and the movable mold 820, even if the mold clamping force F is low, the fixed mold 810 and the movable mold 820 are not opened, and no burr is formed. Burring is a phenomenon in which the molding material M leaking between the fixed mold 810 and the movable mold 820 solidifies.

If the mold clamping force F is large, and a mold clamping pressure P2 is larger than a mold filling pressure P1, the fixed mold 810 and the movable mold 820 are not opened upon the molding material M reaching the parting surfaces 830 between the fixed mold 810 and the movable mold 820. Therefore, the molding material M does not leak, and no burr is formed. The mold clamping pressure P2 is a value obtained by dividing the mold clamping force F by the size S of the parting surfaces 830 (P2=F/S).

However, when the fixed mold 810 and the movable mold 820 are not opened, it is difficult for the gas to escape from the inside of the mold device 800 to the outside. When the gas cannot escape, the gas is compressed inside the mold device 800 and generates heat, which may cause gas burning. The gas burning is a phenomenon in which the molding material M flows into the cavity space 801, and thus the gas in the cavity space 801 is compressed and generates heat, and the molding material M is carbonized. Further, when the gas cannot escape, the molding material may not fully spread into the cavity space 801 of the mold device 800, potentially resulting in a short shot of the molded product. Accordingly, a gap for discharging the gas is often provided.

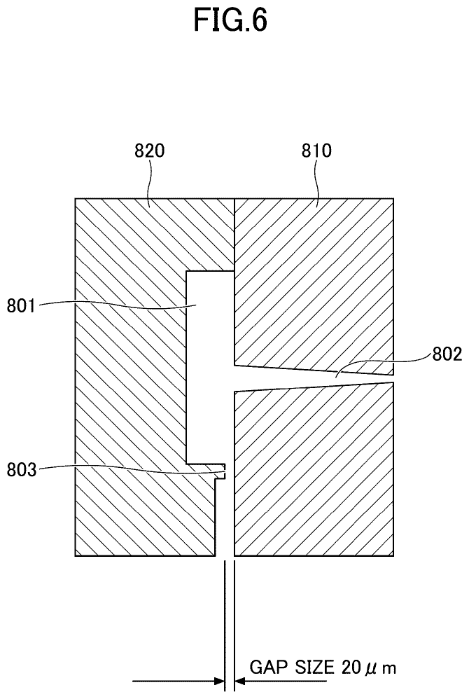

FIG. 6 is a cross-sectional diagram illustrating a mold device 800 according to the present embodiment. In the example illustrated in FIG. 6, a fixed mold 810 and a movable mold 820 included in the mold device 800 are illustrated. In the example illustrated in FIG. 6, a sprue 802 is formed in the fixed mold 810. A runner (not illustrated) may be provided between the cavity space 801 and the sprue 802.

In the present embodiment, the injection device 300 injects the liquid molding material, and thus the cavity space 801 is filled with the liquid molding material. The mold device 800 is provided with an air vent 803 for discharging air existing in the cavity space 801 before filling and gas generated from a flow front (flow tip) of the molding material during filling when the molding material is filled in the cavity space 801.

The air vent 803 provided in the parting surfaces 830 of the mold device 800 is formed to have a depth such that air and gas are discharged but the molding material is not discharged, that is, the molding material does not become a burr. The depth of the groove of the air vent 803 is determined according to the type of the molding material, and for example, the groove is set to have a depth of several micrometers (μm) to several tens μm. In the example illustrated in FIG. 6, the depth of the groove of the air vent 803 is set to 20 μm.

The air existing in the cavity space 801 before the filling and the gas generated from the flow front (flow tip) of the molding material during the filling are discharged to the outside of the cavity space 801 through the air vent 803.

Conventionally, a mold device is often clamped with a large clamping force that does not open the parting surfaces. However, in such a situation, since no gap is formed during filling of the molding material, the gas is discharged only through the air vent. When the air and gas are concentrated in the air vent, the speed of the air and gas passing through the air vent increases, and the resistance increases when passing through the air vent, so that the air and gas are not easily discharged, or the gas is cooled when passing through the air vent, and as a result, the components contained in the gas are deposited in the air vent to form mold deposits, and as a result of repeated injection molding, the air vent is blocked.

Therefore, it is desirable to adjust the mold clamping force so that the parting surfaces are slightly opened at the time of filling to facilitate the discharge of air and gas, but not to discharge the molding material.

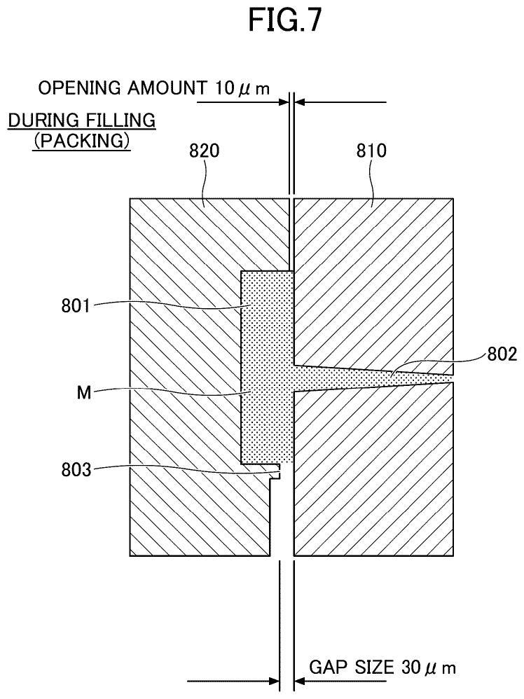

FIG. 7 is a cross-sectional diagram illustrating a state where the parting surfaces 830 of the mold device 800 according to the present embodiment are opened. In the example illustrated in FIG. 7, a fixed mold 810 and a movable mold 820 included in the mold device 800 are illustrated.

In the example illustrated in FIG. 7, when the molding material M reaches the parting surfaces 830 between the fixed mold 810 and the movable mold 820, a gap is formed between the fixed mold 810 and the movable mold 820 due to the filling pressure.

In the example illustrated in FIG. 7, the opening size of the gap is 10 μm. The depth of the groove of the air vent 803 is 20 μm. In the example illustrated in FIG. 7, the sum of the opening size of 10 μm and the depth of 20 μm of the groove of the air vent 803, that is, 30 μm, is the size of the gap formed in the mold device 800. In the present embodiment, the gap is expressed by a numerical value of the SI unit system, but the present disclosure is not limited thereto. Further, the size of the gap itself such as the dimension does not need to be used, and an amount related to the size of the gap or a parameter calculated by substituting the amount related to the size of the gap into a predetermined function may be used, and further, a substitute variable related to the size of the gap may be used.

In the present embodiment, when the molding material is injected into the mold device 800, in order to reduce the injection of the molding material from the mold device 800, the maximum value allowed as the size of the gap between the fixed mold 810 and the movable mold 820, in other words, the maximum value of the size of the gap is defined as a maximum allowable value (an example of an allowable amount). The maximum allowable value is an example of the allowable amount, and the maximum value of the size of the gap itself does not need to be used. Any value may be used as long as the value represents the allowable amount of the size of the gap, such as a parameter calculated by substituting the amount of the size of the gap into a predetermined function, or a substitute variable of the size of the gap, or the like. The maximum allowable value varies depending on the type of the molding material.

That is, when the sum of the opening size of the gap and the depth of the groove of the air vent 803 is equal to or less than the maximum allowable value corresponding to the type of the molding material, the discharge of the molding material can be reduced, and the air and the gas can be discharged from the gap and the air vent 803. In the example illustrated in FIG. 7, if the maximum allowable value corresponding to the type of the molding material is 30 μm or less, the discharge of the molding material from the mold device 800 is prevented.

Therefore, the control device 700 according to the present embodiment adjusts the mold clamping force so that the sum of the opening size of the gap and the depth of the groove of the air vent 803 is equal to or less than the maximum allowable value.

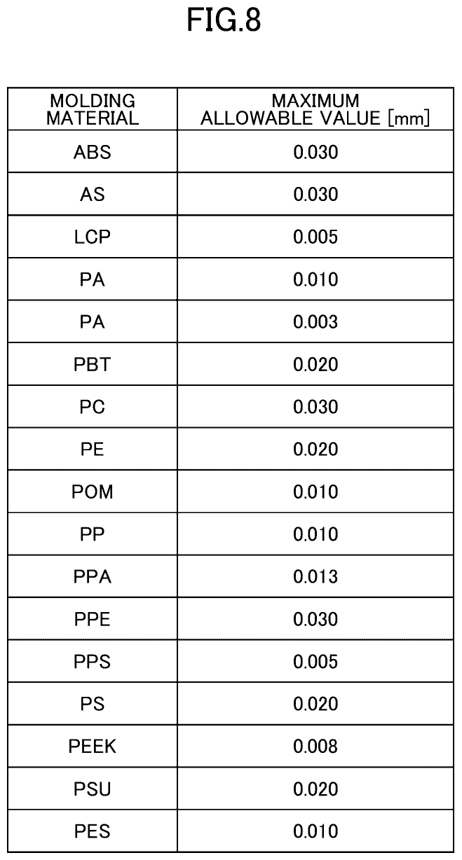

Returning to FIG. 3, the maximum allowable value storage unit 721 of the storage medium 702 stores the maximum allowable value for each molding material used in the injection molding machine 10. FIG. 8 is a diagram illustrating a table structure of the maximum allowable value storage unit 721 according to the present embodiment. As illustrated in FIG. 8, the maximum allowable value storage unit 721 stores (the type of) the molding material and the maximum allowable value in association with each other. For example, the maximum allowable value for the molding material “ABS” is 0.03 mm (=30 μm). Therefore, when the molding material “ABS” is used, in the example illustrated in FIG. 7, if the depth of the groove of the air vent 803 is 20 μm and the opening size is 10 μm, the sum of the opening size of the gap and the depth of the groove of the air vent 803 is 30 μm, and thus the molding material “ABS” is prevented from being discharged from the cavity space 801.

As illustrated in FIG. 8, the maximum allowable value varies depending on the type or characteristics of the molding material. Further, the maximum allowable value at which no burr is formed and no gas burn occurs varies depending on the viscosity of the molding material (depending on the type of resin and temperature). In the case of a molding material having a high viscosity and a low fluidity, the maximum allowable value is about 100 μm, and in the case of a low-viscosity resin, the maximum allowable value is about 5 μm. The maximum allowable values vary depending on the solidification speed of the molding material in the cavity space 801, that is, the temperature of the mold device 800, the temperature (melt viscosity) of the molding material, the melting point and the injection speed (shear heat and, heat transfer from the resin to the mold) of the molding material, and the speed during holding pressure, which are thus not constant under all conditions; however, the numerical values illustrated in FIG. 8 may be used provided that the maximum allowable values are substantially constant under all conditions in this embodiment.

Returning to FIG. 3, the acquiring unit 713 acquires a detection result by a sensor provided in the injection molding machine 10 from the injection molding machine 10. The acquiring unit 713 acquires information input by the user from the operation device 750.

Specifically, the acquiring unit 713 acquires the actual value of the mold clamping force using a mold clamping force detector such as the tie bar strain detector 141.

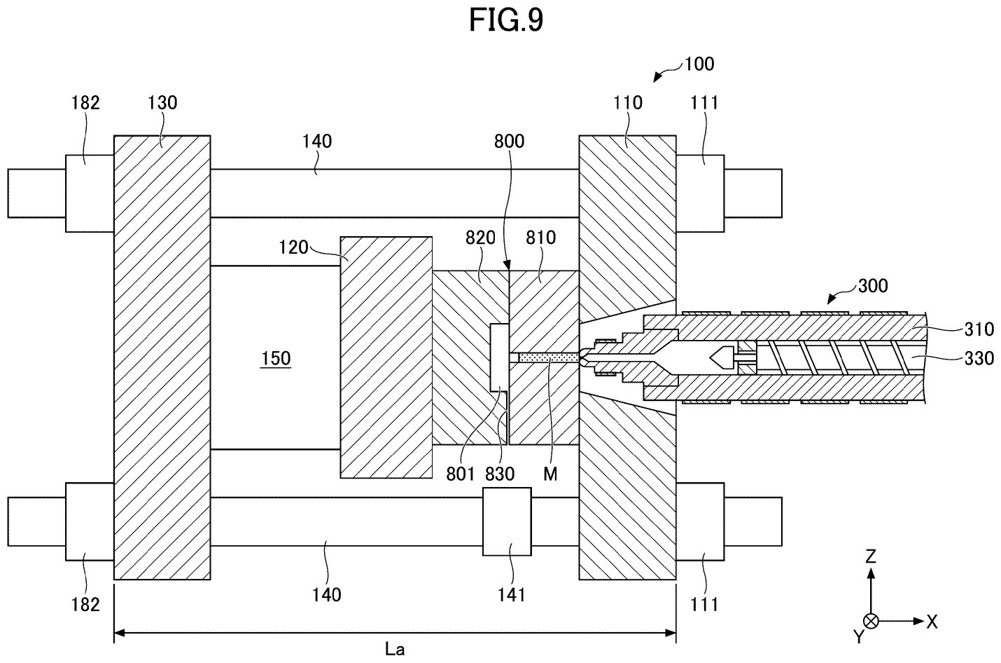

The tie bar strain detector 141 detects a change in the effective length La of the tie bar 140 as illustrated in FIG. 9. The effective length La of the tie bar 140 is the length of the portion of the tie bar 140 that extends according to the mold clamping force F. For example, the effective length La of the tie bar 140 is the length of a portion of the tie bar 140 between the fixing nut 111 and the screw nut 182 acting as an adjustment nut.

The fixing nut 111 is screwed onto a screw shaft formed at the front end of the tie bar 140, and is held so as to be non-rotatable and non-advanceable/non-retractable with respect to the stationary platen 110. On the other hand, the screw nut 182 is screwed onto a screw shaft formed at the rear end of the tie bar 140, and is held so as to be rotatable with respect to the toggle support 130 and so as not to be able to advance and retract. The effective length La of the tie bar 140 can be adjusted by rotating the screw nut 182.

The effective length La of the tie bar 140 changes according to the mold clamping force F. The tie bar strain detector 141 detects the actual value of the mold clamping force by detecting a change in the length La. The acquiring unit 713 acquires the actual value of the mold clamping force from the tie bar strain detector 141.

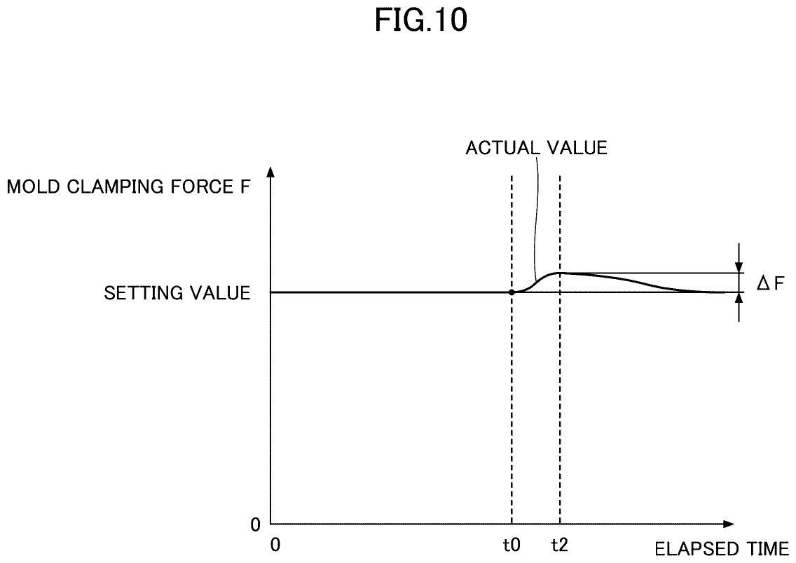

Next, a change in the mold clamping force of the injection molding machine 10 will be described. FIG. 10 is a diagram illustrating a change in the mold clamping force when the molding material is injected in the injection molding machine 10 according to the present embodiment.

As illustrated in FIG. 10, after the start of the injection step, the actual value of the mold clamping force F is stable at the set value until time t0 at which the molding material M reaches the parting surfaces 830 between the fixed mold 810 and the movable mold 820. During this time, the fixed mold 810 and the movable mold 820 are closed as illustrated in FIG. 10. In the present embodiment, the actual value of the mold clamping force F is stabilized at the set value, but the actual value of the mold clamping force F may be stabilized at a value shifted from the set value.

In the present embodiment, the mold clamping force until a force is applied in the direction opposite to the mold clamping force by the internal pressure of the molding material filled in the cavity space 801 after the cavity space 801 is closed is referred to as a reference mold clamping force.

After the start of the injection step, the fixed mold 810 and the movable mold 820 are closed until time t0, and the actual value of the mold clamping force F is stable at the set value, in other words, the reference mold clamping force.

When the molding material M reaches the parting surfaces 830 between the fixed mold 810 and the movable mold 820 at time t0 and the mold filling pressure P1 is larger than the mold clamping pressure P2, the fixed mold 810 and the movable mold 820 are opened by the mold filling pressure P1. As a result, a gap is formed between the fixed mold 810 and the movable mold 820 as illustrated in FIG. 7. The effective length La of the tie bar 140 is increased by the size of the gap, and the actual value of the mold clamping force F is increased as compared with the reference mold clamping force.

Therefore, a rise range ΔF of the actual values of the mold clamping force F corresponds to the size of the gap formed between the fixed mold 810 and the movable mold 820. That is, the larger the size of the gap, the larger the rise range ΔF.

In the present embodiment, the largest mold clamping force is referred to as a peak mold clamping force. In the example illustrated in FIG. 10, at time t2, the actual value of the clamping force detected by the tie bar strain detector 141 is the peak mold clamping force.

The control device 700 according to the present embodiment adjusts the reference mold clamping force so that the molding material is not discharged from the mold device 800 even when the mold device 800 is opened by the peak mold clamping force.

Therefore, the acquiring unit 713 acquires information indicating the depth (an example of a gap size indicating the size of a gap) of the groove of the air vent (an example of a gap) 803 of the mold device 800 attached to the injection molding machine 10. The information indicating the depth of the groove of the air vent 803 may be received from the user, for example. These are examples of the gap size, and the size of the gap itself such as the dimension does not need to be used, and a parameter calculated by substituting an amount relating to the size of the gap into a predetermined function, a substitute variable relating to the size of the gap, or the like may be used.

Further, when adjusting the mold clamping force, the acquiring unit 713 acquires the maximum allowable value corresponding to the type of the molding material used by the injection molding machine 10 with reference to the maximum allowable value storage unit 721. The acquiring unit 713 may receive the type of the molding material used by the injection molding machine 10 as, for example, an input from the user. The acquiring unit 713 may acquire the maximum allowable value input by the user without referring to the maximum allowable value storage unit 721.

Then, the adjustment unit 714 adjusts the reference mold clamping force of the mold clamping device 100 so as to prevent the sum of the opening size between the fixed mold 810 and the movable mold 820 generated by the injection of the molding material and the depth of the groove of the air vent 803 from becoming larger than the maximum allowable value when the molding material is injected into the mold device 800 closed by the mold clamping device 100. In the present embodiment, the maximum value of the size of the gap, which is an example of the allowable amount, the opening size between the fixed mold 810 and the movable mold 820, which is an example of the opening size, and the depth of the groove of the air vent 803, which is an example of the gap size, are all expressed by the metric system of the SI unit system. Therefore, in the present embodiment, the adjustment unit 714 simply compares the sum of the opening size between the fixed mold 810 and the movable mold 820 and the depth of the groove of the air vent 803 with the maximum allowable value, but the condition for adjusting the reference mold clamping force is not limited to the result of the simple comparison. For example, one or more of the opening size and the groove depth may be weighted using a coefficient, or a result calculated by substituting one or more of the opening size and the groove depth into a function or the like may be used. The value obtained based on both the gap size indicating the size of the gap and the opening size indicating the size of the gap between the fixed mold 810 and the movable mold 820 may be adjusted to satisfy the condition based on the allowable amount.

For example, when the ABS resin is used, the maximum allowable value is 30 μm as illustrated in FIG. 8. When the depth of the groove of the air vent of the mold device 800 is 20 μm, no burr is formed even if the gap between the fixed mold 810 and the movable mold 820 is opened by 10 μm. On the other hand, when the depth of the groove of the air vent of the mold device 800 is 10 μm, no burr is formed even if the groove is opened by 20 μm.

Therefore, specifically, the adjustment unit 714 adjusts the mold clamping force of the mold clamping device 100 so as to prevent the sum of the opening size corresponding to the peak mold clamping force and the depth of the groove of the air vent from becoming larger than the maximum allowable value.

The relationship between the stress a generated in the tie bar 140 and the strain amount a generated in the tie bar 140 can be expressed by Equation (1). Note that the Young's modulus of the tie bar 140 is E. The stress a is a stress when the mold clamping force is the highest, in other words, at the time of the peak mold clamping force. The opening size corresponding to the peak mold clamping force is ΔL, and the effective length of the tie bar 140 is La.

$$σ = E ε = E \times Δ L / La \qquad ( 1 )$$

The stress σ can be expressed as Fd/A. The force Fd is a difference between the peak mold clamping force and the reference mold clamping force. The area A is the total cross-sectional area of the tie bars 140 (in the case of four tie bars, the cross-sectional area per one tie bar×4). Therefore, Expression (2) can be derived.

$$Fd / A = E \times Δ L / La \qquad ( 2 )$$

As illustrated in Expression (2), a change in the force Fd between the peak mold clamping force and the reference mold clamping force, that is, the amount of change in the clamping force when the molding material is injected corresponds to the opening size ΔL of the mold device 800.

Therefore, the adjustment unit 714 according to the present embodiment adjusts the reference mold clamping force based on the amount of change in the actual value of the mold clamping force (difference in the force Fd between the peak mold clamping force and the reference mold clamping force) detected by the tie bar strain detector 141 when the molding material is injected, and thus can adjust the mold clamping force based on the opening size ΔL.

The opening size ΔL of the mold device 800 can be calculated from “FdLa/AE” by Expression (2). Then, the adjustment unit 714 according to the present embodiment determines whether the opening size ΔL of the mold device 800 is an amount capable of preventing the discharge of the molding material. In particular, if the opening size ΔL is equal to or less than “L1−L2,” the discharge of the molding material can be prevented. L1 is set to the maximum allowable value, and L2 is set to the depth of the groove of the air vent 803 of the mold device 800. From the relationship between Expression (2) and “L1−L2,” Expression (3) can be derived.

$$L 1 - L 2 \geq Δ L = F dLa / AE \qquad ( 3 )$$

The following Expression (4) is derived from the Expression (3).

$$Fd \leq ( L 1 - L 2 ) AE / La \qquad ( 4 )$$

When the difference in the force Fd between the peak mold clamping force and the reference mold clamping force satisfies Expression (4), the opening size ΔL is set to a degree at which the discharge of the molding material can be prevented. In other words, the adjustment unit 714 can determine whether or not the opening size ΔL is an opening size of a degree of preventing the discharge of the molding material by determining whether or not Expression (4) is satisfied.

Incidentally, if the reference mold clamping force is increased, the difference in the force Fd between the peak mold clamping force and the reference mold clamping force becomes smaller. If the reference mold clamping force is reduced, the difference in the force Fd between the peak mold clamping force and the reference mold clamping force increases.

That is, the adjustment unit 714 may set the reference mold clamping force to be large in a case where Expression (4) is not satisfied. In this way, the adjustment unit 714 repeats the adjustment of the reference mold clamping force so as to satisfy Expression (4). Thus, the reference mold clamping force can be set so that the occurrence of burrs can be prevented.

Further, the adjustment unit 714 according to the present embodiment also adjusts the reference mold clamping force such that the difference in the force Fd between the peak mold clamping force and the reference mold clamping force approaches (L1−L2)AE/La.

That is, by setting the reference mold clamping force to be high, the difference in the force Fd between the peak mold clamping force and the reference mold clamping force becomes small, and thus, Expression (4) can be satisfied. However, when the reference mold clamping force is high, it is difficult to open the mold device 800. That is, the control device 700 adjusts the reference mold clamping force to be low while satisfying Expression (4), and thus, it is possible to discharge air and gas from the gap opened in the mold device 800 and to prevent the discharge of the molding material from the air vent 803 of the mold device 800.

For example, as the difference in the force Fd between the peak mold clamping force and the reference mold clamping force approaches (L1−L2)AE/La, the gap between the fixed mold 810 and the movable mold 820 is opened as illustrated in FIG. 7, and the air and gas are discharged from the gap, but the discharge of the molding material is prevented. That is, the escape of air and gas is improved, and burrs can be prevented.

Therefore, the adjustment unit 714 according to the present embodiment adjusts the mold clamping force of the mold clamping device 100 so that the sum of the opening size and the depth of the groove of the air vent 803 is prevented from becoming larger than the maximum allowable value and approaches the maximum allowable value.

In practice, the calculation is not limited to the determination of the condition in which the sum of the opening size and the depth of the groove of the air vent 803 is compared with the maximum allowable value as described above, and may be performed using a coefficient or the like as in Expression (4), for example. This is because the actual opening size becomes larger than the opening size ΔL corresponding to the peak mold clamping force due to deflection or the like caused by the configuration of the injection molding machine 10. Therefore, the adjustment unit 714 adjusts the reference mold clamping force in consideration of the allowable error (coefficient) corresponding to the injection molding machine 10, the mold device 800, and the like. The setting related to the allowable error (coefficient) may be input from the user, for example. In the present embodiment, a parameter called “sensitivity” is used as a setting related to the allowable error (coefficient).

The adjustment unit 714 according to the present embodiment calculates a difference in the force Fd between the peak mold clamping force and the reference mold clamping force for each shot from the actual value of the clamping force derived from the tie bar strain detector 141. Then, when the difference in the force Fd between the calculated peak mold clamping force and the reference mold clamping force is included in a target range (an example of a predetermined range), the adjustment of the reference mold clamping force is ended. The target range is determined based on (L1−L2)AE/La and sensitivity described later. A specific method of setting the target range will be described later.

The adjustment unit 714 adjusts the reference mold clamping force when the difference between the peak mold clamping force and the reference mold clamping force is not included in the target range.

The output control unit 715 outputs information to an external device. For example, the output control unit 715 outputs a display screen to the display device 760.

The log information processing unit 716 performs processing related to log information. For example, the log information processing unit 716 may determine whether or not an abnormality has occurred based on the log information.

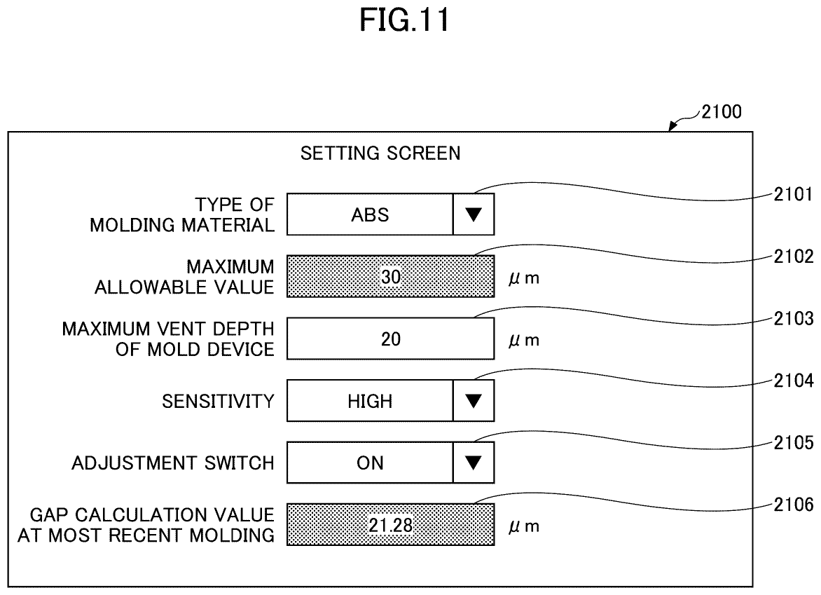

FIG. 11 is a diagram illustrating an example of a setting screen output to the display device 760 by the output control unit 715 according to the present embodiment. As illustrated in FIG. 11, the setting screen 2100 includes a molding material type selection field 2101, a maximum allowable value display field 2102, a setting field 2103 for the maximum vent depth of the mold device, a sensitivity selection field 2104, an adjustment switch selection field 2105, and a display field 2106 for the gap calculation value at the most recent molding.

The molding material type selection field 2101 is, for example, a pull-down menu, and a list of types of molding materials is displayed so as to be selectable. In the example illustrated in FIG. 11, the selection of “ABS” is received from the user.

In the maximum allowable value display field 2102, the maximum allowable value corresponding to the type of the molding material of which the selection is received in the type of the molding material type selection field 2101 is displayed by the output control unit 715. The maximum allowable value can be derived from the type of the molding material of which the selection is received and the maximum allowable value corresponding to the type of the molding material stored in the maximum allowable value storage unit 721.

When the selection of the molding material is not received in the molding material type selection field 2101, the maximum allowable value display field 2102 may be a text input field and may directly receive the input of the maximum allowable value from the user.

The setting field 2103 for the maximum vent depth of the mold device is a text input field that can be input by the user, and receives input of the maximum depth of the groove of the air vent 803 provided in the mold device 800 from the user.

The sensitivity selection field 2104 is, for example, a pull-down menu, and receives selection of sensitivity for setting the reference mold clamping force. The sensitivity is a parameter for deriving an allowable error (coefficient) of the mold device 800 attached to the injection molding machine 10. The sensitivity can be selected from, for example, “high,” “medium,” and “low.” The allowable error increases in the order of “high,” “medium,” and “low.” For example, when the mold device 800 has high accuracy and a sufficient thickness (in other words, deflection is unlikely to occur), “high” may be set, and when the mold device 800 has low accuracy and is thin (in other words, deflection is likely to occur), “low” may be set.

Then, the adjustment unit 714 sets the target range based on the sensitivity of which the selection has been received and (L1−L2)AE/La. The method of setting the target range is not limited to the configuration using the method described below, and an appropriate target range may be set according to the characteristics of the mold device 800.

For example, when the adjustment unit 714 receives the selection of “high,” the adjustment unit 714 sets “(L1−L2)AE/La”×0.8 or more and “(L1−L2)AE/La”×0.95 or less as the target range.

For example, when the adjustment unit 714 receives the selection of “middle,” the adjustment unit 714 sets “(L1−L2)AE/La”×0.6 or more and “(L1−L2)AE/La”×0.90 or less as the target range.

For example, when the adjustment unit 714 receives the selection of “low,” the adjustment unit 714 sets “(L1−L2)AE/La”×0.4 or more and “(L1−L2)AE/La”×0.80 or less as the target range.

The adjustment switch selection field 2105 is, for example, a pull-down menu, and receives a selection of whether or not to adjust the reference mold clamping force. For example, either “ON” or “OFF” can be selected. When the selection of “ON” is received, the control device 700 adjusts the reference mold clamping force. When the selection of “OFF” is received, the control device 700 prevents the adjustment of the reference mold clamping force.

The display field 2106 of the gap calculation value at the most recent molding is displayed. An actual value of the mold clamping force detected by the tie bar strain detector 141. The display unit displays a calculated value of the gap of the mold device 800 calculated based on the maximum depth of the groove of the air vent 803.

For example, the adjustment unit 714 derives “FdLa/AE+L2” as the gap calculation value of the mold device 800 every time the injection-molding is performed, and the output control unit 715 outputs the calculated value of the gap of the mold device 800 to the display field 2106 of the gap calculation value at the most recent molding.

Note that FIG. 11 illustrates an example of the setting screen, and the display items and the display mode are not limited to those described above. As the display item, for example, an allowable opening size obtained by subtracting the maximum depth of the groove of the air vent 803 from the maximum allowable value may be displayed. The allowable opening size is calculated by the adjustment unit 714 for each shot, for example.

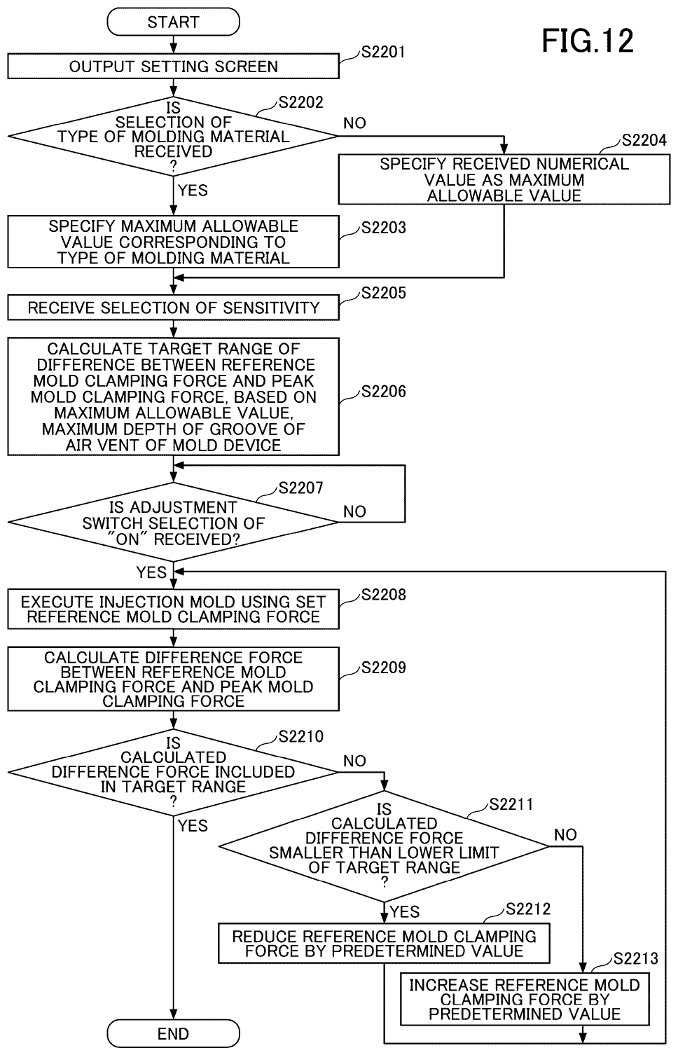

Next, a procedure of a process for adjusting the reference mold clamping force, which is executed by the control device 700 according to the present embodiment, will be described. FIG. 12 is a flowchart illustrating a process procedure for adjusting the reference mold clamping force, which is executed by the control device 700 according to the present embodiment.

First, the output control unit 715 outputs a setting screen to the display device 760 (S2201). As a result, the setting screen 2100 illustrated in FIG. 11 is displayed.

The acquiring unit 713 determines whether or not selection of the type of molding material is received from the type of molding material type selection field 2101 of the setting screen 2100 (S2202). When the acquiring unit 713 determines that the selection has been received (S2202: YES), the acquiring unit 713 specifies the maximum allowable value corresponding to the type of molding material of which the selection has been received with reference to the maximum allowable value storage unit 721 (S2203). Then, the output control unit 715 displays the specified maximum allowable value in the maximum allowable value display field 2102.

When the acquiring unit 713 determines that the selection of the type of molding material type selection field 2101 of the setting screen is not received (S2202: NO), the acquiring unit 713 specifies the numerical value received in the maximum allowable value display field 2102 as the maximum allowable value (S2204).

The acquiring unit 713 receives selection of sensitivity from the sensitivity selection field 2104 (S2205).

The adjustment unit 714 calculates the target range of the difference between the reference mold clamping force and the peak mold clamping force based on the maximum allowable value, the maximum depth of the groove of the air vent of the mold device 800, and the sensitivity (S2206). The method of calculating the target range is as described above, and thus the description thereof will be omitted.

Then, the acquiring unit 713 determines whether or not selection of “ON” is received in the adjustment switch selection field 2105 (S2207). In a state where the selection of “ON” is not received, in other words, the selection of “OFF” is received (S2207: NO), the process waits until the selection of “ON” is received.

When the acquiring unit 713 determines that the selection of “ON” is received in the adjustment switch selection field 2105 (S2207: YES), the control device 700 executes the injection mold using the set reference mold clamping force (S2208). At the first time, an initial value is set as the reference mold clamping force. The initial value may be any value according to the embodiment.

The adjustment unit 714 calculates the difference in the force Fd between the reference mold clamping force and the peak mold clamping force from the actual value of the clamping force detected by the tie bar strain detector 141 (S2209). At this time, the adjustment unit 714 also calculates the calculated value of the gap of the mold device 800. Then, the output control unit 715 displays the calculated value of the gap of the mold device 800 in the display field 2106 of the gap calculated value at most recent molding.

Then, the adjustment unit 714 determines whether or not the calculated difference in the force Fd is included in the target range (S2210).

When the adjustment unit 714 determines that the calculated difference in the force Fd is not included in the target range (S2210: NO), the adjustment unit 714 then determines whether the calculated difference in the force Fd is smaller than the lower limit of the target range (S2211). When the adjustment unit 714 determines that the calculated difference in the force Fd is smaller than the lower limit of the target range (S2211: YES), the adjustment unit 714 reduces the reference mold clamping force by a predetermined value (for example, 10 kN) (S2212).

On the other hand, when the adjustment unit 714 determines that the calculated difference in the force Fd is not smaller than the lower limit of the target range, that is, the calculated difference in the force Fd is not smaller than the target range and is not included in the target range, and thus is larger than the upper limit of the target range (S2211: NO), the adjustment unit 714 increases the reference mold clamping force by the predetermined value (for example, 10 kN) (S2213).

After the S2211 or S2212 process, the control device 700 performs the injection-molding again using the set reference mold clamping force (S2208). The subsequent processing is the S2209 process as described above.

On the other hand, in S2210, when the adjustment unit 714 determines that the calculated difference in the force Fd is included in the target range (S2210: YES), the adjustment unit determines that the adjustment of the reference mold clamping force is completed, and ends the process.

The control device 700 according to the present embodiment performs injection molding using the reference mold clamping force after the adjustment of the reference mold clamping force is completed by the above-described process. At this time, the opening size of the mold device 800 may be monitored. The setting for monitoring may be performed on the log information screen.

In the present embodiment, a case has been described where the reference mold clamping force is adjusted according to whether or not the difference in the force Fd between the reference mold clamping force and the peak mold clamping force is included in the target range when the selection of “ON” is received in the adjustment switch selection field 2105 on the setting screen 2100 of FIG. 11. However, the present embodiment is not limited to the configuration using the method of adjusting the reference mold clamping force only when the selection of “ON” is received in the adjustment switch selection field 2105. For example, even when the adjustment switch selection field 2105 is not provided, the reference mold clamping force may be automatically adjusted according to whether or not the difference in the force Fd between the reference mold clamping force and the peak mold clamping force is included in the target range.

As a further modification, when the difference in the force Fd between the reference mold clamping force and the peak mold clamping force is not included in the target range, the output control unit 715 outputs an inquiry screen of whether or not the reference mold clamping force may be changed to the display device 760. On the inquiry screen, the current reference mold clamping force, a message inquiring whether or not the current reference mold clamping force may be changed, an “OK” button, and a “Cancel” button are displayed. Then, when the acquiring unit 713 receives the pressing of the “OK” button from the user via the operation device 750, the adjustment unit 714 adjusts the reference mold clamping force. The method of adjusting the reference mold clamping force is the same as the above-described method, and a description thereof will be omitted. On the other hand, when the acquiring unit 713 receives the pressing of the “Cancel” button from the user via the operation device 750, the processing for adjusting the reference mold clamping force by the adjustment unit 714 is ended, and the current reference mold clamping force is maintained. In the present modification, the reference mold clamping force is adjusted only when permission is received from the user, and therefore, it is possible to prevent erroneous adjustment of the reference mold clamping force and to realize improvement in the quality of the molded product.

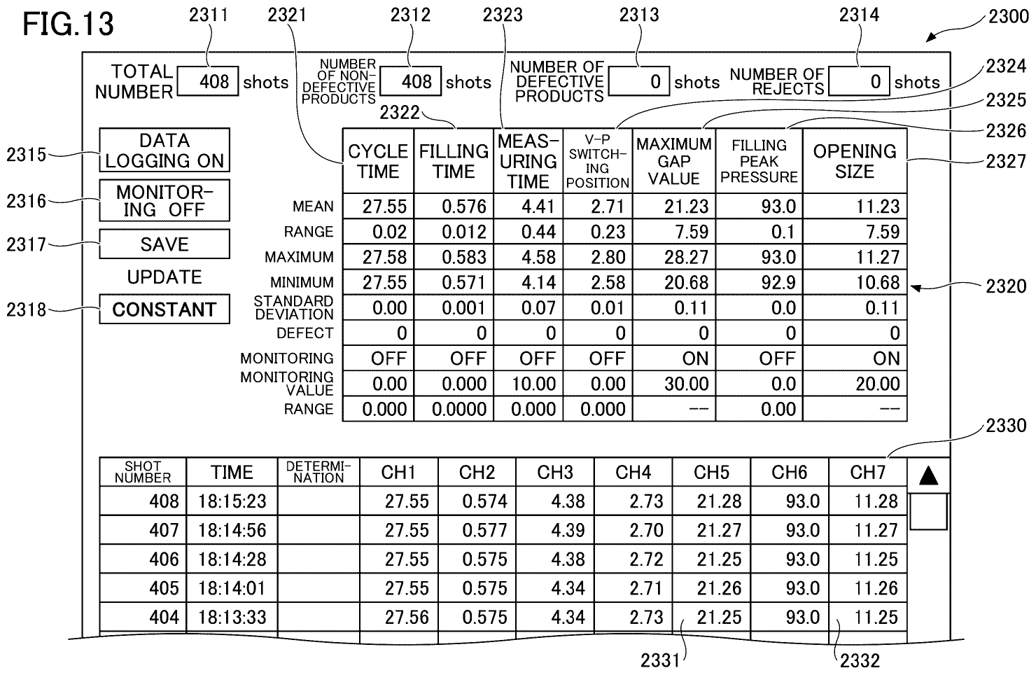

Returning to the embodiment, FIG. 13 is a diagram illustrating an example of a log information screen output by the output control unit 715 according to the present embodiment. The log information screen illustrated in FIG. 13 displays log information relating to injection molding. Further, the log information screen allows the log information processing unit 716 to make settings for storing log information.

The log information screen 2300 illustrated in FIG. 13 includes a total number 2311, a number of non-defective products 2312, a number of defective products 2313, a number of rejects 2314, a logging button 2315, a monitoring setting button 2316, a save button 2317, an update button 2318, a statistics list 2320, and an actual result list 2330.

The statistics list 2320 illustrates statistical information (for example, the mean, the range, the maximum, the minimum, and the standard deviation) for each of the setting fields 2321 to 2327. The contents displayed in the setting fields 2321 to 2327 can be set by the user. In the present embodiment, items displayed in the setting fields 2321 to 2327 can be displayed, monitored, and log information can be stored. The monitoring in the present embodiment represents determination of whether or not a product is a non-defective product based on a predetermined criterion.

The statistical information is information calculated based on the actual value (an example of a parameter) obtained every time a molded product is manufactured by performing injection molding with the injection molding machine 10, and includes, for example, the mean, the range, the maximum, the minimum, and the standard deviation calculated for each of the setting fields 2321 to 2327 in the statistics list 2320. Note that the present embodiment illustrates an example of the statistical information, and statistical information other than the mean, the range, the maximum, the minimum, and the standard deviation, for example, an integral value or the like may be used. In addition, the items of which the statistical information is calculated are not limited to the items set in the setting fields 2321 to 2327, and may be other items.

The output control unit 715 calculates statistical information based on the actual values (an example of parameters) obtained by the various sensors by the injection molding in the range illustrated in the actual result list 2330. Then, the output control unit 715 displays the calculated statistical information in the statistics list 2320.

The “monitoring,” the “monitoring value,” and the “range” of the statistics list 2320 are information for determining whether or not the molded product in the setting field is defective.

When the monitoring of the statistics list 2320 is “OFF,” the control device 700 does not perform monitoring, and when the monitoring is “ON,” the control device 700 performs monitoring. In the case of “ON,” the control device 700 determines whether or not the measured performance value in the item indicated in the setting field satisfies the criteria indicated by “monitoring value” and “range” (for example, whether or not the measured performance value is included in “range” with “monitoring value” as the median). As another example, the control device 700 may determine whether or not the set monitoring value is set as the median and satisfies a criterion based on a set plus tolerance and a set minus tolerance, or whether or not the set monitoring value satisfies a criterion based on a set upper limit value and a set lower limit value. The method of monitoring the actual value is not limited to the above-described method, and any method may be used. The switching of the monitoring is performed by the monitoring setting button 2316.

The “defect” of the statistics list 2320 indicates the number of molded products that do not satisfy the criteria indicated by the “monitoring value” and the “range.”

The “cycle time” in the setting field 2321, “filling time” in the setting field 2322, and the “measuring time” in the setting field 2323 are respective items set to monitor the time required for the cycle, filling, and measuring.

The “V/P switching position” of the setting field 2324 is an item set to monitor the position (V/P switching position) of the screw 330 when the process is switched from the filling step to the packing pressure step.

The “maximum gap value” of the setting field 2325 is an item set to monitor the maximum value of the gap of the mold device 800 (the sum of the maximum depth of the groove of the air vent 803 of the mold device 800 and the opening size corresponding to the peak mold clamping force).

For example, the output control unit 715 displays “FdLa/AE+L2” calculated by the adjustment unit 714 in the setting field 2325 as a numerical value indicating the sum of the maximum depth of the groove of the air vent 803 and the opening size corresponding to the peak mold clamping force. Note that “FdLa/AE+L2” is based on the above-described Expression (3).

The “filling peak pressure” in the setting field 2326 is an item set for monitoring the peak value of the pressure when the molding material is filled.

The “opening size” in the setting field 2327 is an item set for monitoring the opening size corresponding to the peak mold clamping force.

For example, the output control unit 715 displays “FaLa/AE” calculated by the adjustment unit 714 in the setting field 2327 as a numerical value indicating the opening size corresponding to the peak mold clamping force. Note that “FaLa/AE” is based on the above-described Expression (3).

The setting fields 2321 to 2327 can be changed to items that the user desires to monitor. The description of the changing method is omitted.

For example, since the “maximum gap value” of the setting field 2325 is “ON” in the monitoring, the log information processing unit 716 monitors whether or not an abnormality has occurred. In the example illustrated in FIG. 13, the monitoring value “30.00” is set as the maximum allowable value. Then, the log information processing unit (an example of a processing unit) 716 monitors whether or not the “maximum gap value” (the sum of the opening size and the maximum depth of the groove of the air vent 803) is larger than the monitoring value “30.00” (an example of an allowable amount). For example, the log information processing unit 716 determines that there is an abnormality when the “maximum gap value” is larger than the monitoring value “30.00.” Then, when the “maximum gap value” calculated for each shot is larger than the monitoring value “30.00,” the log information processing unit 716 counts the shot as a defective product because there is a possibility that a burr has occurred.

As another example, since the “opening size” of the setting field 2327 is “ON” in the monitoring, the log information processing unit 716 determines whether or not an abnormality has occurred. In the example illustrated in FIG. 13, the monitoring value “20.00” is set as the maximum opening size of the mold device 800. For example, the log information processing unit 716 monitors whether or not the “opening size” is larger than the monitoring value “20.00.” For example, the log information processing unit 716 determines that there is an abnormality when the “opening size” is larger than the monitoring value “20.00.” Then, when the “opening size” calculated for each shot is larger than the monitoring value “20.00,” the log information processing unit 716 counts the shot as a defective product because there is a possibility that a burr has occurred.

In FIG. 13, for the sake of explanation, an example in which the “maximum gap value” and the “opening size” are set in the setting fields is illustrated, but the present disclosure is not limited to the configuration using the method of setting the “maximum gap value” and the “opening size,” and only one of the “maximum gap value” and the “opening size” may be set.

The actual result list 2330 represents a list of setting information (for example, setting values) in the items set in the setting fields 2321 to 2327 or performance values measured by various sensors for each shot. The items set in the setting fields 2321 to 2327 are set from “CH1” to “CH7.” Further, for each shot, “shot number,” “time” when injection molding is performed, and “identification” of injection molding are associated as information indicating the shot.

The logging button 2315 is a button for receiving selection of whether or not to save the performance value illustrated in the actual result list 2330 as log information. When the logging button 2315 is pressed (“data logging ON” is displayed), the log information processing unit 716 stores the information (for example, actual values obtained by various sensors) indicated in the actual result list 2330 and other information in the storage medium 702 as log information.

That is, in the present embodiment, the maximum value of the gap of the mold device 800 for each shot (the sum of the maximum depth of the groove of the air vent 803 of the mold device 800 and the opening size corresponding to the peak mold clamping force), the opening size corresponding to the peak mold clamping force, and the like can be stored in the storage medium 702 as log information.

The monitoring setting button 2316 is a button for receiving whether or not to monitor according to the items to be monitored in the statistics list 2320. When the monitoring setting button 2316 is pressed (“monitoring ON” is displayed), each shot is monitored to see whether it is defective or not, and the monitoring results are included in the log information. When the monitoring setting button 2316 is pressed, the monitoring can be switched to “OFF” or “ON” for each of the setting fields 2321 to 2327 in the statistics list 2320.

The save button 2317 is a button for receiving whether or not to save the statistical value (for example, mean, range, maximum, minimum, standard deviation, or the like) for each of the setting fields 2321 to 2327. When the save button 2317 is pressed, the log information processing unit 716 saves the statistical value for each of the setting fields 2321 to 2327 and the actual value indicated in the actual result list 2330 in the storage medium 702 as log information. In the present embodiment, an example of storing the statistical value and the actual value will be described, but the present disclosure is not limited to the example of storing of the statistical value and the actual value. For example, when a setting is indicated in the actual result list 2330, the log information processing unit 716 may also store the setting value. Furthermore, even if the setting value is not indicated in the actual result list 2330, the log information processing unit 716 may store the setting value in association with the actual result value indicated in the actual result list 2330.

The update button 2318 is a button for receiving whether or not to update the statistics list 2320 and the actual result list 2330 every time injection molding by the injection molding machine 10 is completed. When the update button 2318 is pressed (“always” is displayed), the statistics list 2320 and the actual result list 2330 are updated every time injection molding by the injection molding machine 10 is completed.

The total number 2311 indicates the number of molded products molded by the injection molding machine 10. The number of non-defective products 2312 indicates the number of molded products determined to be good products based on the “monitoring,” the “monitoring value,” and the “range.” The number of defective products 2313 indicates the number of molded products determined to be defective based on the “monitoring,” the “monitoring value,” and the “range.” The number of rejects 2314 indicates the number of rejected molded products.

As described above, when the injection molding machine 10 produces a molded product from a molding material, the output control unit 715 of the control device 700 displays, for each molded product, the actual values (an example of detection results) detected by the various sensors in the process of producing the molded product in the actual result list 2330 of the display device 760.

For example, in the actual result list 2330, “CH5” corresponds to “maximum gap value.” That is, in the field 2331 of “CH5” of the actual result list 2330, the maximum value of the gap of the mold device 800 (the sum of the maximum depth of the groove of the air vent 803 of the mold device 800 and the opening size corresponding to the peak mold clamping force) is displayed as the actual result value for each shot.

As another example, in the actual result list 2330, “CH7” corresponds to “opening size.” That is, in the field 2332 of “CH7” of the actual result list 2330, the opening size of the mold device 800 at the time when the peak mold clamping force is detected is displayed as an actual result value for each shot.

Further, when the logging button 2315 is pressed, the log information processing unit 716 stores information (for example, actual values by various sensors) illustrated in the actual result list 2330 in the storage medium 702 as log information, and thus the maximum value of the gap of the mold device 800 and the opening size of the mold device 800 when the peak mold clamping force is detected are stored in the storage medium 702 as log information. Therefore, the opening size of the mold device 800 can be managed for each molded product.

In the log information screen 2300 illustrated in FIG. 13, the “maximum gap value” and the “opening size” are displayed for each shot, and thus the user can visually recognize whether or not there is a possibility that a burr has occurred in the molded product.

The screen to be monitored by the output control unit 715 is not limited to the log information screen as illustrated in FIG. 13.

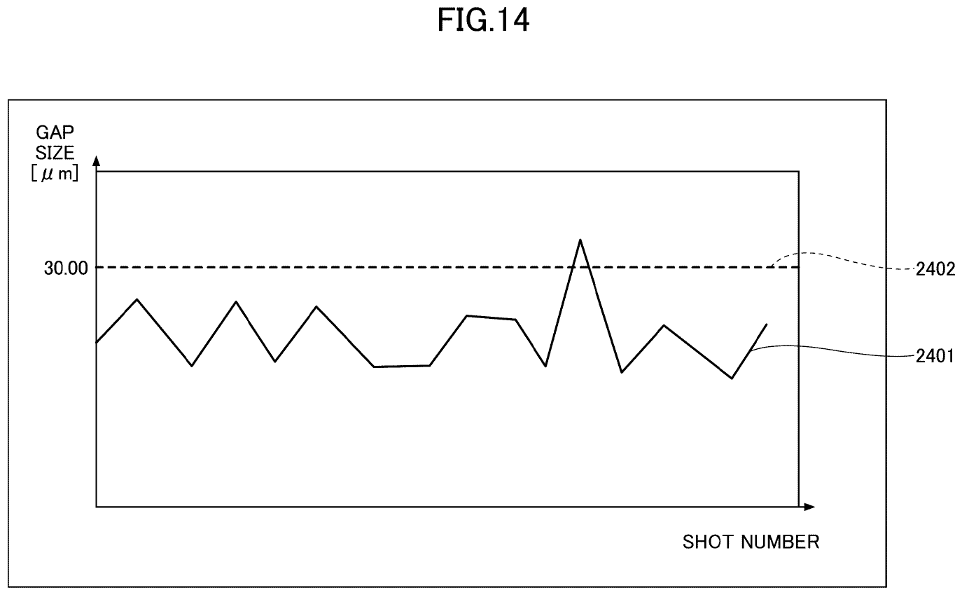

FIG. 14 is a diagram illustrating an example of a gap size display screen output by the output control unit 715 according to the present embodiment. The gap size display screen illustrated in FIG. 14 displays the gap size for each shot by a line 2401. The gap size for each shot is the sum of the maximum depth of the groove of the air vent 803 of the mold device 800 and the opening size corresponding to the peak mold clamping force.

Further, a threshold 2402 which is a reference for discharging the molding material from the mold device 800 can be set on the gap size display screen. In the example illustrated in FIG. 14, “30.00” is set as the threshold value.

Then, the user can confirm in chronological order whether or not the waveform indicating the gap size for each shot exceeds the threshold 2402 by referring to the gap size display screen. That is, the user can recognize a timing at which a defective product may have been produced due to burrs.

In the present embodiment, the example in which the calculation is performed on the assumption that the amount of change in the mold clamping force detected by the tie bar strain detector 141 corresponds to the amount of opening between the fixed mold 810 and the movable mold 820 formed by the injection of the molding material has been described. However, the present embodiment is not limited to the configuration using method of calculating the opening size between the fixed mold 810 and the movable mold 820 generated by the injection of the molding material as the amount corresponding to the amount of change in the mold clamping force detected by the tie bar strain detector 141, and a detection result of another sensor (for example, a distance sensor capable of detecting the opening size) may be used.

### Another Embodiment

In the above-described embodiment, an example in which the control device 700 of the injection molding machine 10 adjusts the mold clamping force of the mold device 800 has been described. However, the above-described embodiment is not limited to the configuration using the method in which the control device 700 of the injection molding machine 10 adjusts the mold clamping force of the mold device 800. Another embodiment is an example in which a group management device (an example of a control device) that controls a plurality of injection molding machines 10 manages the injection molding machines 10.

For example, when the mold devices 800 having the same shapes and using the same type of molding material are used in the plurality of injection molding machines 10, a group management device adjusts the reference mold clamping force for each of the plurality of injection molding machines 10 at once. For example, the group management device performs the same control as in the above-described embodiment using any one of the plurality of injection molding machines 10.

In the present embodiment, the group management device adjusts the reference mold clamping force for each of the plurality of injection molding machines 10 at once, and thus it is possible to reduce the work load.

### Operation

The control device 700 according to the present embodiment performs the above-described processing. Therefore, by selecting the type of molding material or inputting the maximum allowable value, and inputting the maximum depth of the groove of the air vent of the mold device 800, the user can have the control device 700 adjust the mold clamping force to a reference mold clamping force so that an air and a gas are discharged and no burr is formed, without having to check whether or not there is a burr in the molded product. Therefore, the user does not have to manually adjust the mold clamping force while checking whether or not burrs are formed in the molded product, and thus it is possible to reduce the operation burden.

Conventionally, it is difficult for an unskilled person to adjust the reference mold clamping force. However, in the present embodiment, the control device 700 performs the above-described processing, and thus it is possible to equalize the quality of the molded product regardless of whether the person is skilled. Therefore, the quality of the molded product can be improved.

The control device 700 according to the present embodiment adjusts the reference mold clamping force to be within a target range, and thus can adjust the size of the gap formed between the parting surfaces 830 of the mold device 800 at the time of filling to such an extent that the air and the gas can be discharged but the molding material cannot be discharged. Therefore, the air and the gas are easily discharged from the gap formed in the parting surfaces 830, and thus it is possible to prevent the discharge of the air and the gas from being concentrated on the air vent 803. Therefore, since the occurrence of mold deposits in the air vent 803 can be reduced, the time until the air vent 803 is blocked can be extended. Therefore, the interval for cleaning the mold device 800 can be increased. Therefore, the work efficiency can be improved and the cleaning load can be reduced.

As a method of detecting the opening size of the mold device, there is a method of installing a sensor capable of detecting the gap size between the parting surfaces between the movable mold and the fixed mold of the mold device. Then, a method of adjusting the gap size of the mold device by the control device from the detection result of the sensor may be considered. When this method is used, it is necessary to install sensors as many as the number of mold devices. Further, when the sensor is transferred to the mold device, the sensor needs to be adjusted, and thus, a load and time for the adjustment are required. In addition, in the injection molding machine, since vibration is generated due to injection molding or opening and closing of the mold device, there is a possibility that a positional deviation between the mold device and the sensor, that is, a deviation in a detection result occurs.

In contrast, in the above-described embodiment, since the tie bar strain detector 141 is installed on the tie bar 140, it is not necessary to perform the reinstallation and readjustment of the sensor when the mold device 800 is replaced. Further, since the strain amount of the tie bar 140 is detected, the effect of the deviation due to the vibration can be reduced. Therefore, it is possible to reduce the work load of the user and to prevent the occurrence of an error in the vibration. Therefore, the detection accuracy can be improved, and thus the occurrence of molding defects can be prevented.

Further, a method of calculating the opening size between the parting surfaces of the mold device by the filling pressure of the mold device is considered. When the opening size between the parting surfaces of the mold device is calculated by the filling pressure, there are many factors which determine the magnitude of the filling pressure, and the magnitude of the filling pressure is not directly related to the opening size of the mold device in many cases. Factors for determining the magnitude of the filling pressure include the mean temperature of the molding material, the magnitude of temperature unevenness of the molding material, the density of the molding material, the temperature of the cavity/runner portion of the mold device, the closed state of the screw during filling, the amount of drooling (running) before injection, and the like. These factors can easily change the viscosity of the filled resin or the pressure drop, resulting in a change in the filling pressure. Further, the gap size between the parting surfaces of the mold device is obtained by adding factors of the rigidity of the mold clamping device and the rigidity of the mold device. Changes in these factors make a difference between the force on the cavity space and the filling pressure. Therefore, it is considered that the calculation of the opening size based on the filling pressure causes a large error.

In contrast, the control device 700 according to the above-described embodiment performs calculation based on the gap size of the parting surfaces 830 of the mold device 800 from the strain amount of the tie bar 140. In this method, since the number of factors is smaller than the number of factors of the filling pressure, deviation is less likely to occur; thus, it is possible to improve the accuracy of adjustment of the reference mold clamping force.

Further, a method of installing a pressure sensor in the cavity space and adjusting the reference mold clamping force based on a detection result of the pressure sensor is also considered. However, the temperature of the cavity space is about 200° C. depending on the molding material, and therefore, the number of types of sensors that can be used is small. Further, since the pressure sensor is repeatedly brought into a high-pressure state by injection molding, the pressure sensor has a high risk of abnormality in such a high-load environment. When the pressure sensor fails, the mold device needs to be disassembled in order to remove the pressure sensor and attach a new pressure sensor. Therefore, such work requires considerable effort and time. In addition, since it is necessary to install a pressure sensor for each mold device, the cost of the mold device increases.

In contrast, the control device 700 according to the present embodiment uses the detection result of the tie bar strain detector 141. Therefore, even when a plurality of mold devices 800 are present, the tie bar strain can be measured by one tie bar strain detector 141 attached to the injection molding machine 10, and thus the cost can be reduced. Further, since the tie bar strain detector 141 is attached to the tie bar 140, the load of temperature and pressure can be reduced as compared with the case of using a pressure sensor, and therefore, the risk of occurrence of abnormality can be reduced and replacement can be easily performed. Therefore, since the occurrence of the abnormality can be prevented, the detection accuracy can be improved, and thus the occurrence of the molding defect can be prevented. Further, since the replacement can be easily performed, the work load can be reduced.

The control device 700 according to the present embodiment calculates a gap size formed between the parting surfaces 830 in consideration of the maximum depth of the groove of the air vent 803. Since the maximum depth of the groove of the air vent 803 and the gap size are in the same unit of distance, conversion or calculation is not necessary. Therefore, it is possible to prevent an error from occurring due to the conversion or calculation, and thus it is possible to realize improvement in accuracy. That is, in consideration of the depth of the groove of the air vent 803, it is possible to prevent the discharge of the molding material and to improve the accuracy in adjusting the reference mold clamping force capable of discharging air and gas. That is, the control device 700 according to the present embodiment can adjust the reference mold clamping force in both cases of, for example, a case where the air vent 803 is not provided in the mold device 800 and a case where the air vent 803 having a depth close to the upper limit of the maximum allowable value is provided in the mold device 800.

Although the embodiment of the control device for an injection molding machine according to the present disclosure has been described above, the present disclosure is not limited to the above-described embodiments and the like. Various changes, modifications, substitutions, additions, deletions, and combinations are possible within the scope of the claims. Such modifications and the like are also included in the technical scope of the present disclosure.

What is claimed is:

1. A control device for controlling an injection molding machine, the control device comprising:
a mold device having a fixed mold and a movable mold;
a mold clamping device configured to open and close the fixed mold and the movable mold;
an injection device configured to inject a molding material into the mold device; and
circuitry configured to
acquire an allowable amount as a size of a gap allowable between the fixed mold and the movable mold for preventing discharge of the molding material from the mold device when the molding material is injected into the mold device, and acquire a gap size indicating a size of a gap provided for discharging a gas between the fixed mold and the movable mold, and
adjust a mold clamping force of the mold clamping device such that a value obtained based on an opening size and the gap size satisfies a condition according to the allowable amount when the molding material is injected into the mold device closed by the mold clamping device, the opening size indicating a size of a gap between the fixed mold and the movable mold generated by injection of the molding material.

2. The control device according to claim 1, wherein the circuitry adjusts the mold clamping force applied to the mold device by the mold clamping device such that the value based on the opening size and the gap size satisfies the condition according to the allowable amount, and approaches the allowable amount.

3. The control device according to claim 1, wherein the circuitry
acquires the mold clamping force from a detection result of a detection device, the detection device being provided in a tie bar that extends according to the mold clamping force, and
adjusts the mold clamping force of the mold clamping device based on an amount of change in the mold clamping force when the molding material is injected into the mold device.

4. The control device according to claim 1, wherein the circuitry acquires the gap size, an input of the gap size being received from an operation device.

5. The control device according to claim 1, wherein the circuitry acquires the allowable amount corresponding to a type of the molding material, an input of the type of the molding material being received from an operation device.

6. The control device according to claim 1, wherein the circuitry further configured to output, to a display device, one or more of the allowable amount, the opening size, and the value based on the opening size and the gap size.

7. The control device according to claim 1, wherein the circuitry further configured to monitor whether or not the value based on the opening size and the gap size satisfies the condition according to the allowable amount every time the molding material is injected into the mold device closed by the mold clamping device.
